(19) United States
(12) Patent Application Publication
(10) Pub. No.: US 2010/0234263 A1
(43) Pub. Date: Sep. 16, 2010

(54) NANO-FLUIDS AS CLEANING COMPOSITIONS FOR CLEANING SOILED SURFACES, A METHOD FOR FORMULATION AND USE

(75) Inventors: Darsh T. Wasan, Darien, IL (US); Alex D. Nikolov, Chicago, IL (US); Michael Ray McDonald, Middletown, OH (US); Stacie Ellen Hecht, West Chester, OH (US)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignees: THE PROCTER & GAMBLE COMPANY, CINCINNATI, OH (US); ILLINOIS INSTITUTE OF TECHNOLOGY, CHICAGO, IL (US)

(21) Appl. No.: 12/293,714

(22) PCT Filed: Mar. 21, 2007
(86) PCT No.: PCT/US07/07032

§ 371 Date: Nov. 20, 2008

Related U.S. Application Data
(60) Provisional application No. 60/784,152, filed on Mar. 21, 2006.
(60) Provisional application No. 60/784,153, filed on Mar. 21, 2006.

(51) Int. Cl. C11D 3/12; C11D 3/37

(52) U.S. Cl. 510/218; 510/245; 510/276; 510/475; 510/508; 510/511

(57) ABSTRACT

A cleaning composition comprising from about 0.001% to about 25% of nanoparticles comprising a water insoluble metal or semimetal compound having an effective diameter of less than about 65 nanometers, a grass stain removal index greater than 0 and a grease stain removal index greater than 0; and adjunct ingredients.

### CROSS-REFERENCE TO RELATED APPLICATIONS

This application claims the benefit of U.S. Provisional Application Ser. No. 60/784,152, filed Mar. 21, 2006 and U.S. Provisional Application Ser. No. 60/784,153, filed Mar. 21, 2006, each of which is incorporated in its entirety by reference.

### FIELD OF THE INVENTION

The present invention relates to nano-fluids comprising aqueous suspensions of hydrophilic nanoparticles or polymers, useful in soil removal from hard, semi-hard and soft surfaces. The nano-fluids can be used as cleaning compositions. These nano-fluids can be used with or without the wetting agents for consumer detergency applications. The present nano-fluids have improved ability to remove grass and grease stains.

### BACKGROUND

The cleaning of soils and stains from fabric and other surfaces continues to be a desired ability of cleaning compositions, such as laundry detergents and dishwashing detergents.

Improved removal of grass and grease stains is a constant goal of cleaning product manufacturers. Enzymes, surfactant, and polymer additives have been used in cleaning detergents for years to remove stains.

Nano-sized particles, or nanoparticles, have been disclosed for a variety of purposes including the treatment and coating of hard surfaces, coating of soft surfaces, and treating synthetic resin films. See U.S. Pat. No. 5,429,867, 5,853,809, U.S. Pat. No. 6,693,071, U.S. 2002/0176982. Nanoparticles have also been previously disclosed for detergent and dishwashing compositions, and compositions for cleaning vehicles. See U.S. Pat. No. 4,597,886, U.S. Pat. No. 6,562,142, WO 01/27236, and WO 01/32820.

Despite the prior work done with nanoparticles in cleaning compositions, a need still exists for cleaning products that improve stain removal by using specific nanoparticle compositions.

### SUMMARY

Disclosed herein are new cleaning compositions, termed “nano-fluids,” and methods of soil/pollutant removal (cleaning) using nano fluids with and without wetting agents. The mechanism of this type of detergency is based on the structural forces arising from the self-organization of nanoparticles in the three-phase contact region (i.e., wedge film) present on a solid surface.

The present invention relates to cleaning compositions comprising from about 0.001% to about 25% of nanoparticles comprising a water insoluble metal, semimetal compound, or a hydrophilic globular-sized polymer, said nanoparticles having an effective diameter of less than about 65 nanometers (nm), in a suspension medium. In some embodiments, the cleaning compositions have a grass stain removal index greater than 0 and a grease stain removal index greater than 0. In certain embodiments, the nanoparticles can have an effective diameter of 40 nm or less, or can be about 5 nm to about 25 nm or about 10 nm to about 65 nm. Preferably, the nanoparticles are monodisperse in diameter. Typically, monodisperse nanoparticles have a standard deviation of less than about 10%, less than about 8%, less than about 5%, or less than about 4% of the mean diameter of the nanoparticles.

The nanoparticles used in the present cleaning compositions can be any shape or mixture of shapes, but a preferred shape of the nanoparticles is spherical. “Spherical,” as used herein, refers to the diameter of a nanoparticle in any direction be within 10% of a diameter of the nanoparticle in a different direction. For example, a spherical nanoparticle having a width of about 50 nm will have a length and height of about 45 nm to about 55 nm.

In various embodiments, the amount of the nanoparticles in the cleaning composition are about 0.001% to about 25% effective volume of the total volume of the cleaning composition. In specific embodiments, the amount of the nanoparticles is about 5% to about 25% effective volume of the total volume of the cleaning composition. The disclosed cleaning compositions can be used as a laundry detergent, a liquid dishwashing detergent, a car cleaning composition, a textile treating composition, or an industrial degreasing composition.

In some embodiments, the nanoparticles comprise silicon dioxide, titanium dioxide, zinc oxide, aluminum oxide, ethylene-methacrylic acid copolymer, particles derived from natural minerals, synthetic particles, or combinations thereof.

The surface of the nanoparticles can further comprise a modified surface. Specifically, the surface of the nanoparticles can comprise a hydration layer, an electrical double layer, one or more polymer, or a combination thereof. Additionally and alternatively, the surface of the nanoparticle can comprise a wetting agent, such as a surfactant like sodium dodecyl sulfate.

The disclosed cleaning compositions can have osmotic pressures of at least 650 Pa.

### BRIEF DESCRIPTION OF THE DRAWINGS

FIG. 1. Nanoparticle structuring mechanism for soil cleaning action. A. Particle structuring inside the wedge film and spreading of nano-fluid between the soil and the solid surface. B. Disjoining pressure as a function of wedge film (meniscus) thickness and equations for film tension (γ) and spreading coefficient (5).

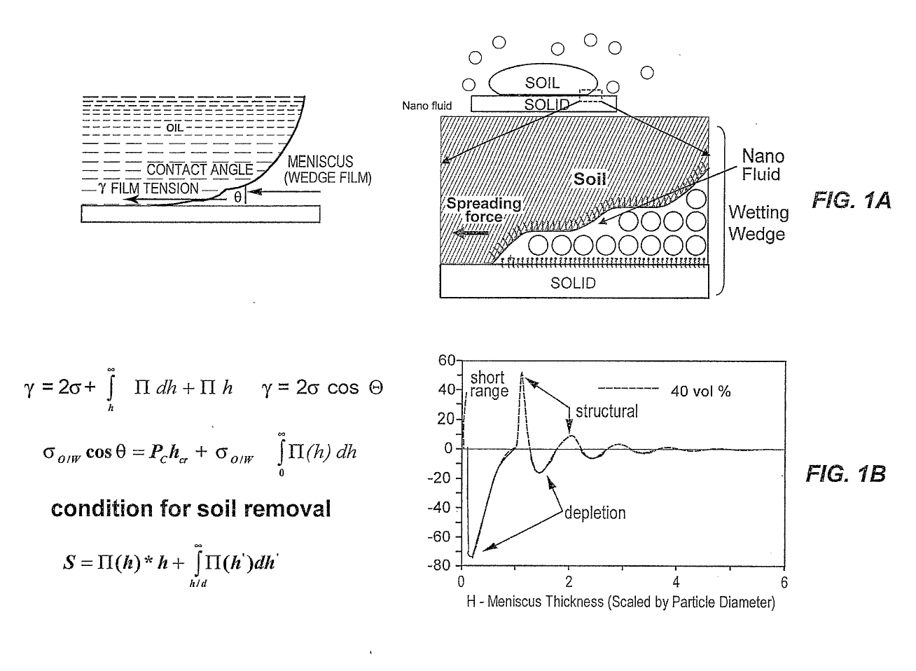

FIG. 2. Apparatus and experimental set-up for monitoring soil cleaning action.

FIG. 3. Photomicrographs taken at increasing times after addition of the nano-fluid formulation (15 wt % Nalco 1130 with 3×10 M SDS) against hexadecane oil drop on a glass surface at 25° C. A. Top view; B. Side view

FIG. 4. Cleaning dynamics of 15 wt % Nalco 1130+3×10 SDS in hard water (h.w.) and deionized water against hexadecane oil drop on a glass surface at 25° C.

FIG. 5. Comparison of cleaning dynamics of 15 wt % Nalco 1130+3×10 M 5135 with 3×10′ M SDS along against hexadecane oil drop on a glass surface.

FIG. 6. Comparison of cleaning dynamics of 30 wt % of Nalco 1130 against canola oil drop on a glass surface at 25° C. with both 0.15 wt % Tide solution, and alkaline solution alone.

FIG. 7. Photomicrographs taken at increasing times for the nano-fluid formulation (14.0 wt % S-100) against canola oil.

FIG. 8. Cleaning dynamics of nano-fluid formulation 5-100 at pH=9.7 against hexadecane and canola oil on a glass surface at 25° C.

FIG. 9. Surface tension isotherm of CHEMPEARL' S-100 at 25° C.

FIG. 10. Cleaning dynamics of nano-fluid ‘SNOWTEX-40’ against canola oil and hexadecane on a glass surface at 25° C.

FIG. 11. Cleaning dynamics of ST-C and ST-N both at 20 wt % against canola oil on a glass surface at 25° C.

FIG. 12. Time to separate canola oil drop from a glass surface at 25° C. versus pH for various nano-fluid formulations at different concentrations.

FIG. 13. Cleaning action of nano-fluid ST-40 and S-100 and Tide solution against canola oil on a textile cotton sheet at 25° C.

FIG. 14. Cleaning action of nano-fluids ST-40 and 5-100 and Tide solution against canola oil on a single cotton fiber at 25° C.

### DETAILED DESCRIPTION

It is well known that common laundry detergents (surfactant micelles) are derived from costly petroleum products. This invention features the use of environmentally friendly nanofluids that are composed of nanoparticle suspensions in water. The nanoparticles, having a diameter less than 10 nm, are hydrophilic (i.e, water wet) and, therefore, biodegradable, unlike detergent cleaning formulations, which are unstable aggregates and non-biodegradable.

The method of formulating the nano-fluids useful for cleaning soiled hard or soft surfaces is based on the repulsive structural force (originating from difference in osmotic pressure between the wedge film and the cleaning composition) resulting from the ordered nanoparticle structure formation inside the wedge region. Additional novel features of the present method include: (1) a preferred nano-fluid formulation optimized based on a positive second virial coefficient combined with a high osmotic pressure; (2) determination of effective volume (concentration) of the nano-fluid formulation containing nanoparticles with large hydration layers, electrical double layers or grafted polymer layers using a capillary force balance in conjunction with the common reflected light interferometric method; (3) a wetting agent at a concentration of 100 ppm; and (4) determination of wettability (as measured by the threephase contact angle) of the substrate using a differential interferometric method, which is especially suited for turbid nanoparticle suspensions and non-smooth (rough) substrates, such as cotton fibers.

This method using nano-fluids for cleaning soils performs better in conjunction with the flow that assists in removing the soil from the substrate.

Wetting films of nanofluids that contain self-organized structures, such as suspensions of nanoparticles, polymer latexes, globular proteins, and surfactant micelles have significant technological applications in both nanotechnology and biological systems. For example, thin films of nanofluids are spread on solid surfaces to build magnetic light sensitive tapes and disks. Nanostructured materials such as color inks, solar cells, light emitting displays, and biochemical sensors are other examples.

### Nanoparticles

The cleaning compositions of the present invention comprise from about 0.001% to about 25%, from about 0.01% to about 20%, from about 0.1% to about 5%, from about 0.2% to about 2%, or even from about 0.5 to about 1% of nanoparticles. This percentage is based upon the effective volume of the cleaning composition. The nanoparticle has a certain density, which is dependent upon the size, shape, or ionic properties of the nanoparticle. Therefore, high density nanoparticles will require a greater weight percent of the total cleaning composition to occupy the same volume as that of lower density nanoparticles. The volume that the nanoparticles occupy in the total volume of the cleaning composition is readily determinable by the following equation

$${V}_{eff} = {{V}_{geom} ( 1 + \frac{δ}{{R}_{par}} )}^{3} ,$$

where δ is defined as a region of particle/particle interactions, Rₚₐᵣ is the particle radius and V_{geom} is the geometric volume.

The nanoparticles comprise a water-insoluble metallic or semimetallic compound and have an effective diameter of less than about 65 nanometers, or from about 1 to about 50 nanometers, from about 10 to about 40 manometers, from about 15 to about 30 nanometers, or even 20 to about 30 nanometers. The nanoparticles also have a grass stain removal index (“Grass SRI”) greater than 0, greater than about 2, or greater than about 4 and a grease stain removal index (“Grease SRI”) greater than 0, greater than about 2, or greater than about 4.

By metallic or semimetallic compound, it is meant any inorganic compound which contains at least one metal or semimetal atom in its structure. One embodiment of the nanoparticles are selected from the group consisting of SiO₂, TiO, ZnO, Al₂O₃ and mixtures thereof.

The nanoparticles can alternatively be comprised of hydrophilic globular-sized polymers. Hydrophilic polymers include polymers of ethylene glycol, polyesters, polyamines, polyacrylates, and block co-polymers of the same. One example of a block co-polymer is ethylene-methacrylic acid copolymer. Typically, the molecular weight of such hydrophilic polymers is about 10 kDa to about 100 kDa.

The effective diameter of the nanoparticles of the present invention is the average diameter of the particle of the total compound as it exists in solution. It is recognized that nanoparticles may initially be formed at much smaller diameters, however they agglomerate into stable particles in solution. The effective diameter is the diameter of the final stable particles, even if the particle is an agglomeration of smaller particles. The effective diameter may be measured by any typical light scattering measurement device, such as the Zeta Plus-Zeta Potential Analyzer from Brookhaven Instruments Corporation. The effective diameter of the nanoparticles discussed herein were measured on a Zeta Plus-Zeta Potential Analyzer having version 3.37 Zeta Plus Particle Sizing software. The instrument was used by inserting a 1 mL sample cuvette into the instrument and running with the following conditions:
Angle=90°
Temperature=25° C.
Runs=6
Run Duration=30 seconds
Real Refractive Index of particles=1.590
Imaginary Refractive Index of particles=0
Dust Cutoff=50

It has been found that selected nanoparticles, comprising the stated composition, have the following effective diameters.

TABLE 1

| | | Effective | |
|---|---|---|---|
| Nanoparticle | Material | Diameter | Brandname |
| A | SiO₂ | 25.5 nm | Nanomer 4 ™ from Nalco |
| B | Metallic salt | 21.9 nm | S-100 from Mitsui |
| | of ethylene- | | |
| | methacrylic | | |
| | acid copolymer | | |
| C | SiO₂ | 33.1 nm | Snowtex NT ™ from Nissan |
| D | SiO₂ | 60.4 nm | Snowtex 40 ™ from Nissan |

The nanoparticles of the present invention have both a Grass Stain Removal Index (SRI) greater than 0 and a Grease Stain Removal Index (SRI) greater than 0. The Grass and Grease SRI are measured by the GRASS and GREASE STAIN REMOVAL INDEX test method described in the Test Method section below. Some typical nanoparticles were measured to have the following SRI's.

TABLE 2

| | Particle | | |
|---|---|---|---|
| Nanoparticle | Concentration | Grass SRI | Grease SRI |
| A | 15.0% | 4.5 | 3.3 |
| A | 5.0% | 4.1 | 4.9 |
| B | 27.0% | −4.8 | −3.4 |
| B | 13.5% | −4.3 | −1.2 |
| B | 5.0% | −3.2 | 1.6 |
| C | 20.3% | 4.7 | 1.4 |
| D | 40.8% | 5.8 | −5.4 |
| D | 10.2% | 3.2 | −3.5 |
| D | 5.0% | 0.7 | −1.5 |

As can be seen from the data in Table 2, it has been found that nanoparticle A (Nanomer 4™) and nanoparticle C (Snowtex N™) are examples of nanoparticles that show positive stain removal or both grass and grease.

### Cleaning Compositions

As used herein, the term “cleaning composition” includes, unless otherwise indicated, granular or powder-form all-purpose or “heavy-duty” washing agents, especially laundry detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse aid types for household and institutional use; liquid cleaning and disinfecting agents, including antibacterial hand-wash types, laundry bars, mouthwashes, denture cleaners, car or carpet shampoos, bathroom cleaners; hair shampoos and hair-rinses; shower gels and foam baths and metal cleaners; as well as cleaning auxiliaries such as bleach additives and “stain-stick” or pre-treat types.

The cleaning compositions comprise nanoparticles and a suspension medium. The suspension medium is an aqueous medium, which can optionally comprise compatible additives, such as salts, enzymes, and the like.

### Liquid Laundry Detergent Compositions

In one specific embodiment, the compositions are laundry detergent composition and are liquid in form and comprise heavy duty liquid compositions. The laundry detergent composition comprises a surfactant in an amount sufficient to provide desired cleaning properties. In one embodiment, the laundry detergent composition comprises, by weight, from about 5% to about 90% of the surfactant, and more specifically from about 5% to about 70% of the surfactant, and even more specifically from about 5% to about 40%. The surfactant may comprise anionic, nonionic, cationic, zwitterionic and/or amphoteric surfactants. In a more specific embodiment, the detergent composition comprises anionic surfactant, nonionic surfactant, or mixtures thereof.

Suitable anionic surfactants useful herein can comprise any of the conventional anionic surfactant types typically used in liquid detergent products. These include the alkyl benzene sulfonic acids and their salts as well as alkoxylated or non-alkoxylated alkyl sulfate materials.

Exemplary anionic surfactants are the alkali metal salts of C₁₀₋₁₆ alkyl benzene sulfonic acids, preferably C₁₁₋₁₄ alkyl benzene sulfonic acids. Preferably the alkyl group is linear and such linear alkyl benzene sulfonates are known as “LAS”. Alkyl benzene sulfonates, and particularly LAS, are well known in the art. Such surfactants and their preparation are described for example in U.S. Pat. Nos. 2,220,099 and 2,477,383. Especially preferred are the sodium and potassium linear straight chain alkylbenzene sulfonates in which the average number of carbon atoms in the alkyl group is from about 11 to 14. Sodium C₁₁-C₁₄, e.g., C₁₂, LAS is a specific example of such surfactants.

Another exemplary type of anionic surfactant comprises ethoxylated alkyl sulfate surfactants. Such materials, also known as alkyl ether sulfates or alkyl polyethoxylate sulfates, are those which correspond to the formula: R′—O—(C₂H₄O)ₙSO₃M wherein R′ is a C₈-C₂₀ alkyl group, n is from about 1 to 20, and M is a salt-forming cation. In a specific embodiment, R′ is C₁₀-C₁₈ alkyl, n is from about 1 to 15, and M is sodium, potassium, ammonium, alkylammonium, or alkanolammonium. In more specific embodiments, R′ is a C₁₂-C₁₆, n is from about 1 to 6 and M is sodium.

The alkyl ether sulfates will generally be used in the form of mixtures comprising varying R′ chain lengths and varying degrees of ethoxylation. Frequently such mixtures will inevitably also contain some non-ethoxylated alkyl sulfate materials, i.e., surfactants of the above ethoxylated alkyl sulfate formula wherein n=0. Non-ethoxylated alkyl sulfates may also be added separately to the compositions of this invention and used as or in any anionic surfactant component which may be present. Specific examples of non-alkoxylated, e.g., non-ethoxylated, alkyl ether sulfate surfactants are those produced by the sulfation of higher C₈-C₂₀ fatty alcohols. Conventional primary alkyl sulfate surfactants have the general formula: ROSO₃⁻M⁺ wherein R is typically a linear C₈-C₂₀ hydrocarbyl group, which may be straight chain or branched chain, and M is a water-solubilizing cation. In specific embodiments, R is a C₁₀-C₁₅ alkyl, and M is alkali metal, more specifically R is C₁₂-C₁₄ and M is sodium.

Specific, nonlimiting examples of anionic surfactants useful herein include: a) C₁₁-C₁₈ alkyl benzene sulfonates (LAS); b) C₁₀-C₂₀ primary, branched-chain and random alkyl sulfates (AS); c) C₁₀-C₁₈ secondary (2,3) alkyl sulfates having formulae (I) and (II):

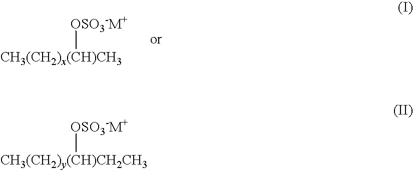

wherein M in formulae (I) and (II) is hydrogen or a cation which provides charge neutrality, and all M units, whether associated with a surfactant or adjunct ingredient, can either be a hydrogen atom or a cation depending upon the form isolated by the artisan or the relative pH of the system wherein the compound is used, with non-limiting examples of preferred cations including sodium, potassium, ammonium, and mixtures thereof, and x is an integer of at least about 7, preferably at least about 9, and y is an integer of at least 8, preferably at least about 9; d) C₁₀-C₁₈ alkyl alkoxy sulfates (AE_{X}S) wherein preferably x is from 1-30; e) C₁₀-C₁₈ alkyl alkoxy carboxylates preferably comprising 1-5 ethoxy units; f) mid-chain branched alkyl sulfates as discussed in U.S. Pat. No. 6,020,303 and U.S. Pat. No. 6,060,443; g) mid-chain branched alkyl alkoxy sulfates as discussed in U.S. Pat. No. 6,008,181 and U.S. Pat. No. 6,020,303; h) modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548; i) methyl ester sulfonate (IVIES); and j) alpha-olefin sulfonate (AOS).

Suitable nonionic surfactants useful herein can comprise any of the conventional nonionic surfactant types typically used in liquid detergent products. These include alkoxylated fatty alcohols and amine oxide surfactants. Preferred for use in the liquid detergent products herein are those nonionic surfactants which are normally liquid.

Suitable nonionic surfactants for use herein include the alcohol alkoxylate nonionic surfactants. Alcohol alkoxylates are materials which correspond to the general formula: R¹(CₘH₂ₘO)ₙOH wherein R¹ is a C₈-C₁₆ alkyl group, m is from 2 to 4, and n ranges from about 2 to 12. Preferably R¹ is an alkyl group, which may be primary or secondary, that contains from about 9 to 15 carbon atoms, more preferably from about 10 to 14 carbon atoms. In one embodiment, the alkoxylated fatty alcohols will also be ethoxylated materials that contain from about 2 to 12 ethylene oxide moieties per molecule, more preferably from about 3 to 10 ethylene oxide moieties per molecule.

The alkoxylated fatty alcohol materials useful in the liquid detergent compositions herein will frequently have a hydrophilic-lipophilic balance (HLB) which ranges from about 3 to 17. More preferably, the HLB of this material will range from about 6 to 15, most preferably from about 8 to 15. Alkoxylated fatty alcohol nonionic surfactants have been marketed under the tradenames Neodol and Dobanol by the Shell Chemical Company.

Another suitable type of nonionic surfactant useful herein comprises the amine oxide surfactants. Amine oxides are materials which are often referred to in the art as “semi-polar” nonionics. Amine oxides have the formula: R(EO)ₓ(PO)_{y}(BO)_{z}N(O)(CH₂R′)₂.gH₂O. In this formula, R is a relatively long-chain hydrocarbyl moiety which can be saturated or unsaturated, linear or branched, and can contain from 8 to 20, preferably from 10 to 16 carbon atoms, and is more preferably C₁₂-C₁₆ primary alkyl. R is a short-chain moiety, preferably selected from hydrogen, methyl and —CH₂OH. When x+y+z is different from 0, EO is ethyleneoxy, PO is propyleneneoxy and BO is butyleneoxy. Amine oxide surfactants are illustrated by C₁₂₋₁₄ alkyldimethylamine oxide.

Non-limiting examples of nonionic surfactants include: a) C₁₂-C₁₈ alkyl ethoxylates, such as, NEODOL nonionic surfactants from Shell; b) C₆-C₁₂ alkyl phenol alkoxylates wherein the alkoxylate units are a mixture of ethyleneoxy and propyleneoxy units; c) C₁₂-C₁₈ alcohol and C₆-C₁₂ alkyl phenol condensates with ethylene oxide/propylene oxide block polymers such as PLURONIC® from BASF, d) C₁₄-C₂₂ mid-chain branched alcohols, BA, as discussed in U.S. Pat. No. 6,150,322; e) C₁₄-C₂₂ mid-chain branched alkyl alkoxylates, BAE_{X}, wherein x is 1-30, as discussed in U.S. Pat. No. 6,153,577, U.S. Pat. No. 6,020,303 and U.S. Pat. No. 6,093,856; f) Alkylpolysaccharides as discussed in U.S. Pat. No. 4,565,647 Llenado, issued Jan. 26, 1986; specifically alkylpolyglycosides as discussed in U.S. Pat. No. 4,483,780 and U.S. Pat. No. 4,483,779; g) Polyhydroxy fatty acid amides as discussed in U.S. Pat. No. 5,332,528, WO 92/06162, WO 93/19146, WO 93/19038, and WO 94/09099; and h) ether capped poly(oxyalkylated) alcohol surfactants as discussed in U.S. Pat. No. 6,482,994 and WO 01/42408.

In the laundry detergent compositions herein, the detersive surfactant component may comprise combinations of anionic and nonionic surfactant materials. When this is the case, the weight ratio of anionic to nonionic will typically range from 10:90 to 90:10, more typically from 30:70 to 70:30.

Cationic surfactants are well known in the art and non-limiting examples of these include quaternary ammonium surfactants, which can have up to 26 carbon atoms. Additional examples include a) alkoxylate quaternary ammonium (AQA) surfactants as discussed in U.S. Pat. No. 6,136,769; b) dimethyl hydroxyethyl quaternary ammonium as discussed in U.S. Pat. No. 6,004,922; c) polyamine cationic surfactants as discussed in WO 98/35002, WO 98/35003, WO 98/35004, WO 98/35005, and WO 98/35006; d) cationic ester surfactants as discussed in U.S. Pat. Nos. 4,228,042, 4,239,660 4,260,529 and U.S. Pat. No. 6,022,844; and e) amino surfactants as discussed in U.S. Pat. No. 6,221,825 and WO 00/47708, specifically amido propyldimethyl amine (APA).

Non-limiting examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 at column 19, line 38 through column 22, line 48, for examples of zwitterionic surfactants; betaine, including alkyl dimethyl betaine and cocodimethyl amidopropyl betaine, C₈ to C₁₈ (preferably C₁₂ to C₁₈) amine oxides and sulfo and hydroxy betaines, such as N-alkyl-N,N-dimethylammino-1-propane sulfonate where the alkyl group can be C₈ to C₁₈, preferably C₁₀ to C₁₄.

Non-limiting examples of ampholytic surfactants include: aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. See U.S. Pat. No. 3,929,678 at column 19, lines 18-35, for examples of ampholytic surfactants.

### Granular Laundry Detergent Compositions

In another specific embodiment, the compositions are laundry detergent composition and are solid in form and comprise granular compositions. The compositions comprise surfactant and a thiazolium dye selected from the same defined group of dyes which have been found to exhibit good tinting efficiency during a laundry wash cycle without exhibiting excessive undesirable build up after laundering.

Granular detergent compositions of the present invention may include any number of conventional detergent ingredients. For example, the surfactant system of the detergent composition may include anionic, nonionic, zwitterionic, ampholytic and cationic classes and compatible mixtures thereof. Detergent surfactants for granular compositions are described in U.S. Pat. No. 3,664,961 and in U.S. Pat. No. 3,919,678. Cationic surfactants include those described in U.S. Pat. No. 4,222,905 and in U.S. Pat. No. 4,239,659.

Nonlimiting examples of surfactant systems include the conventional C11-C18 alkyl benzene sulfonates (“LAS”) and primary, branched-chain and random C₁₀-C₂₀ alkyl sulfates (“AS”), the C10-C18 secondary (2,3) alkyl sulfates of the formula CH₃(CH₂)ₓ(CHOSO₃⁻M⁺)CH₃ and CH₃(CH₂)_{y}(CHOSO₃⁻M⁺)CH₂CH₃ where x and (y+1) are integers of at least about 7, preferably at least about 9, and M is a water-solubilizing cation, especially sodium, unsaturated sulfates such as oleyl sulfate, the C₁₀-C₁₈ alkyl alkoxy sulfates (“AEXS”; especially EO 1-7 ethoxy sulfates), C₁₀-C₁₅ alkyl alkoxy carboxylates (especially the EO 1-5 ethoxycarboxylates), the C₁₀₋₁₈ glycerol ethers, the C₁₀-C₁₈ alkyl polyglycosides and their corresponding sulfated polyglycosides, and C₁₂-C₁₈ alpha-sulfonated fatty acid esters. If desired, the conventional nonionic and amphoteric surfactants such as the C₁₂-C₁₈ alkyl ethoxylates (“AE”) including the so-called narrow peaked alkyl ethoxylates and C₆-C₁₂ alkyl phenol alkoxylates (especially ethoxylates and mixed ethoxy/propoxy), C₁₂-C₁₈ betaines and sulfobetaines (“sultaines”), C₁₀-C₁₈ amine oxides, and the like, can also be included in the surfactant system. The C₁₀-C₁₈N-alkyl polyhydroxy fatty acid amides can also be used. See WO 92/06154. Other sugar-derived surfactants include the N-alkoxy polyhydroxy fatty acid amides, such as C₁₀-C₁₈ N-(3-methoxypropyl) glucamide. The N-propyl through N-hexyl C₁₂-C₁₈ glucamides can be used for low sudsing. C₁₀-C₂₀ conventional soaps may also be used. If high sudsing is desired, the branched-chain C₁₀-C₁₆ soaps may be used. Mixtures of anionic and nonionic surfactants are especially useful. Other conventional useful surfactants are listed in standard texts.

The detergent composition can, and preferably does, include a detergent builder. Builders are generally selected from the various water-soluble, alkali metal, ammonium or substituted ammonium phosphates, polyphosphates, phosphonates, polyphosphonates, carbonates, silicates, borates, polyhydroxy sulfonates, polyacetates, carboxylates, and polycarboxylates. Preferred are the alkali metal, especially sodium, salts of the above. Preferred for use herein are the phosphates, carbonates, silicates, C₁₀₋₁₈ fatty acids, polycarboxylates, and mixtures thereof. More preferred are sodium tripolyphosphate, tetrasodium pyrophosphate, citrate, tartrate mono- and di-succinates, sodium silicate, and mixtures-thereof.

Specific examples of inorganic phosphate builders are sodium and potassium tripolyphosphate, pyrophosphate, polymeric metaphosphate having a degree of polymerization of from about 6 to 21, and orthophosphates. Examples of polyphosphonate builders are the sodium and potassium salts of ethylene diphosphonic acid, the sodium and potassium salts of ethane, 1,1,2-triphosphonic acid. Other phosphorus builder compounds are disclosed in U.S. Pat. Nos. 3,159,581; 3,213,030; 3,422,021; 3,422,137; 3,400,176 and 3,400,148. Examples of nonphosphorus, inorganic builders are sodium and potassium carbonate, bicarbonate, sesquicarbonate, tetraborate decahydrate, and silicates having a weight ratio of SiO₂ to alkali metal oxide of from about 0.5 to about 4.0, preferably from about 1.0 to about 2.4. Water-soluble, nonphosphorus organic builders useful herein include the various alkali metal, ammonium and substituted ammonium polyacetates, carboxylates, polycarboxylates and polyhydroxy sulfonates. Examples of polyacetate and polycarboxylate builders are the sodium, potassium, lithium, ammonium and substituted ammonium salts of ethylene diamine tetraacetic acid, nitrilotriacetic acid, oxydisuccinic acid, mellitic acid, benzene polycarboxylic acids, and citric acid.

Polymeric polycarboxylate builders are set forth in U.S. Pat. No. 3,308,067. Such materials include the water-soluble salts of homo- and copolymers of aliphatic carboxylic acids such as maleic acid, itaconic acid, mesaconic acid, fumaric acid, aconitic acid, citraconic acid and methylenemalonic acid. Some of these materials are useful as the water-soluble anionic polymer as hereinafter described, but only if in intimate admixture with the nonsoap anionic surfactant. Other suitable polycarboxylates for use herein are the polyacetal carboxylates described in U.S. Pat. No. 4,144,226 and U.S. Pat. No. 4,246,495.

Water-soluble silicate solids represented by the formula SiO₂.M₂O, M being a alkali metal, and having a SiO₂:M₂O weight ratio of from about 0.5 to about 4.0, are useful salts in the detergent granules of the invention at levels of from about 2% to about 15% on an anhydrous weight basis. Anhydrous or hydrated particulate silicate can be utilized, as well.

Any number of additional ingredients can also be included as components in the granular detergent composition. These include other detergency builders, bleaches, bleach activators, suds boosters or suds suppressors, anti-tarnish and anti-corrosion agents, soil suspending agents, soil release agents, germicides, pH adjusting agents, nonbuilder alkalinity sources, chelating agents, smectite clays, enzymes, enzyme-stabilizing agents and perfumes. See U.S. Pat. No. 3,936,537.

Bleaching agents and activators are described in U.S. Pat. No. 4,412,934 and in U.S. Pat. No. 4,483,781. Chelating agents are also described in U.S. Pat. No. 4,663,071 Column 17, line 54 through Column 18, line 68. Suds modifiers are also optional ingredients and are described in U.S. Pat. Nos. 3,933,672 and 4,136,045. Suitable smectite clays for use herein are described in U.S. Pat. No. 4,762,645, Column 6, line 3 through Column 7, line 24. Suitable additional detergency builders for use herein are enumerated in U.S. Pat. No. 3,936,537, Column 13, line 54 through Column 16, line 16, and in U.S. Pat. No. 4,663,071.

### Liquid Dish Handwashing Detergent

The liquid dishwashing detergent compositions herein farther contain from about 20% to 80% of an aqueous liquid carrier in which the other essential and optional compositions components are dissolved, dispersed or suspended. More preferably the aqueous liquid carrier will comprise from about 30% to about 70%, more preferable from about 45% to about 65% of the compositions herein.

One preferred component of the aqueous liquid carrier is water. The aqueous liquid carrier, however, may contain non-aqueous liquids, or components which dissolve in the liquid carrier, at room temperature (20° C.-25° C.) and which may also serve some other function besides that of an inert filler. Such materials can include, for example, hydrotropes and solvents, discussed in more detail below. The water in the aqueous liquid carrier can have a hardness level of about 2-30 gpg (“gpg” is a measure of water hardness that is well known to those skilled in the art, and it stands for “grains per gallon”).

The compositions of the present invention are preferably thickened and have package viscosity of greater than 80 cps, when measured at 20° C. More preferably the package viscosity of the liquid detergent composition is less than or equal to 200 cps for Asian regions, such as Japan, and less than or equal to 700 cps for regions such as North America and Western Europe. The present invention excludes compositions which are in the form of microemulsions.

The liquid detergent composition may have any suitable pH. Preferably the pH of the composition is adjusted to between 4 and 14. More preferably the composition has pH of between 6 and 13, most preferably between 6 and 10. The pH of the composition can be adjusted using pH modifying ingredients known in the art.

The liquid detergent composition of the present invention may further comprise surfactants other than the mid-branched amine oxide, C₁₀₋₁₄ alkyl or hydroxyalkyl sulphate or sulphonate, dialkylsulfosuccinate, and linear amine oxides surfactants discussed above, and are selected from nonionic, anionic, cationic, surfactants, ampholytic, zwitterionic, semi-polar nonionic surfactants, and mixtures thereof. Optional surfactants, when present, may comprises from about 0.01% to about 50% by weight of the liquid detergent compositions of the present invention, preferably from about 1% to about 50% by weight of the liquid detergent composition. Non-limiting examples of optional surfactants are discussed below.

A component used in the present invention is linear amine oxides. Amine oxides, for use herein, include water-soluble amine oxides containing one linear and/or branched C₈₋₁₈ g alkyl moiety and 2 moieties selected from the group consisting of C₁₋₃ alkyl groups and C₁₋₃ hydroxyalkyl groups; water-soluble phosphine oxides containing one C₁₀₋₁₈ alkyl moiety and 2 moieties selected from the group consisting of C₁₋₃ alkyl groups and C₁₋₃ hydroxyalkyl groups; and water-soluble sulfoxides containing one C₁₀₋₁₈ alkyl moiety and a moiety selected from the group consisting of C₁₋₃ alkyl and C₁₋₃ hydroxyalkyl moieties.

Preferred amine oxide surfactants have formula (III):

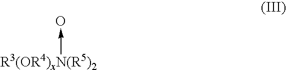

wherein R³ of formula (II) is a linear and/or branched C₈₋₂₂ alkyl, C₈₋₂₂ hydroxyalkyl, C₈₋₂₂ alkyl phenyl group, and mixtures thereof; R⁴ of formula (III) is an C₂₋₃ alkylene or C₂₋₃ hydroxyalkylene group or mixtures thereof; x is from 0 to about 3; and each R⁵ of formula (I) is an C₁₋₃ alkyl or C₁₋₃ hydroxyalkyl group or a polyethylene oxide group containing from about 1 to about 3 ethylene oxide groups. The R⁵ groups of formula (III) can be attached to each other, e.g., through an oxygen or nitrogen atom, to form a ring structure. As used herein “branched” mean a C₁-C₁₁ alkyl moiety.

These amine oxide surfactants in particular include C₁₀-C₁₈ alkyl dimethyl amine oxides and C₈-C₁₂ alkoxy ethyl dihydroxy ethyl amine oxides. Preferred amine oxides include linear and/or branched C₁₀, C₁₀-C₁₂, and C₁₂-C₁₄ alkyl dimethyl amine oxides.

At least one amine oxide will be present in the cleaning composition from about 0.1% to about 15%, more preferably at least about 0.2% to about 12% by weight of the cleaning composition. Most preferably, the amine oxide is present in the cleaning composition from about 1% to about 8% by weight of the cleaning composition.

An optionally component used in the liquid detergent composition of the present invention is linear amine oxides. Amine oxides, for optional use herein, include water-soluble linear amine oxides containing one linear C₈₋₁₈ alkyl moiety and 2 moieties selected from the group consisting of C₁₋₃ alkyl groups and C₁₋₃ hydroxyalkyl groups; water-soluble phosphine oxides containing one linear C₁₀₋₁₈ alkyl moiety and 2 moieties selected from the group consisting of C₁₋₃ alkyl groups and C₁₋₃ hydroxyalkyl groups; and water-soluble sulfoxides containing one linear C₁₀₋₁₈ alkyl moiety and a moiety selected from the group consisting of C₁₋₃ alkyl and C₁₋₃ hydroxyalkyl moieties.

An optional component used in the liquid detergent composition of the present invention is dialkyl sulfosuccinates. The dialkyl sulfosuccinates may be a C₆₋₁₅ linear or branched dialkyl sulfosuccinate. The alkyl moieties may be symmetrical (i.e., the same alkyl moieties) or asymmetrical (i.e., different alkyl moieties). Preferably, the alkyl moiety is symmetrical. The use of the dialkyl sulfosuccinates, without being limited by a theory, improves the hydrophobicity and wetting capability leading to better cleaning results of greasy and/or starch soils. The ClogP of the dialkyl sulfosuccinates is greater than 2.0. The ClogP can be used to distinguish suitable sulfosuccinates, such as the dialkyl sulfosuccinates of the present invention. Preferred ranges for the ClogP are from 2.0 to 6.0, more preferred from 3.0 to 5.5. By comparison, the ClogP of monoalkyl sulfosuccinates is about 1.0.

The ClogP value relates to the octanol/water partition coefficient of a material. Specifically, the octanol/water partition coefficient (P) is a measure of the ratio of the concentration of a particular polymer in octanol and in water at equilibrium. The partition coefficients are reported in logarithm of base 10 (i.e., logP). The logP values of many materials have been reported and may be calculated via various methods including the Pomona92 database, available from Daylight Chemical Information Systems, Inc. and the United States Environmental Protection Agency also has available an Estimation Programs Interface for Windows (EPI-Win) that can be used to calculate the CLogP (or Log Kow). The preferred calculation tool is the EPI-Win model to calculate CLogP or LogKow based on polymer structures.

In one embodiment, the dialkyl sulfosuccinate is preferably branched, more preferably having a C₁-C₃ alkyl branch in the middle of the alkyl moiety (not on the α or β carbon of the alkyl moiety), most preferably from a secondary alcohol source, including, but not limited to, dibutyl hexanol and -dioctyl hexanol. This placement of the branch on the alkyl moiety (not on the α or β carbon of the alkyl moiety) may be referred to as a “mid-chain” branch.

Preferred dialkyl moieties are selected from C₆₋₁₃ linear or branched dialkyl sulfosuccinates. Nonlimiting examples include linear dihexyl sulfosuccinate, branched dioctyl sulfosuccinate and linear bis(tridecyl) sulfosuccinate.

The dialkyl sulfosuccinates may be present in the liquid detergent composition from about 0.5% to about 10% by weight of the composition. In one embodiment, the dialkyl sulfosuccinates are preferably present in the liquid detergent composition from about 2% to about 5% by weight of the composition. In another embodiment, the dialkyl sulfosuccinates are preferably present in the liquid detergent composition from about 1% to about 10% by weight of the composition.

Optionally the nonionic surfactant, when present in the composition, is present in an effective amount, more preferably from 0.1% to 20%, even more preferably 0.1% to 15%, even more preferably still from 0.5% to 10%, by weight of the liquid detergent composition.

Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 20 carbon atoms with from 2 to 18 moles of ethylene oxide per mole of alcohol. Also suitable are alkylpolyglycosides having the formula R²O(CₙH₂ₙO)ₜ(glycosyl)ₓ (formula (IV)), wherein R² of formula (IV) is selected from the group consisting of alkyl, alkyl-phenyl, hydroxyalkyl, hydroxyalkylphenyl, and mixtures thereof in which the alkyl groups contain from 10 to 18, preferably from 12 to 14, carbon atoms; n of formula (IV) is 2 or 3, preferably 2; t of formula (IV) is from 0 to 10, preferably 0; and x of formula (IV) is from 1.3 to 10, preferably from 1.3 to 3, most preferably from 1.3 to 2.7. The glycosyl is preferably derived from glucose. To prepare these compounds, the alcohol or alkylpolyethoy alcohol is formed first and then reacted with glucose, or a source of glucose, to form the glucoside (attachment at the 1-position). The additional glycosyl units can then be attached between their 1-position and the preceding glycosyl units 2-, 3-, 4- and/or 6-position, preferably predominantly the 2-position.

Also suitable are fatty acid amide surfactants having the formula (V):

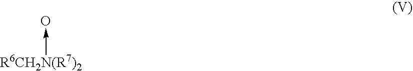

wherein R⁶ of formula (V) is an alkyl group containing from 7 to 21, preferably from 9 to 17, carbon atoms and each R⁷ of formula (V) is selected from the group consisting of hydrogen, C₁-C₄ alkyl, C₁-C₄ hydroxyalkyl, and —(C₂H₄O)ₓH where x of formula (V) varies from 1 to 3. Preferred amides are C₈-C₂₀ ammonia amides, monoethanolamides, diethanolamides, and isopropanolamides.

An optionally component used in the liquid detergent composition of the present invention is linear amine oxides. Amine oxides, for optional use herein, include water-soluble linear amine oxides containing one linear C₈₋₁₈ alkyl moiety and 2 moieties selected from the group consisting of C₁₋₃ alkyl groups and C₁₋₃ hydroxyalkyl groups; water-soluble phosphine oxides containing one linear C₁₀₋₁₈ alkyl moiety and 2 moieties selected from the group consisting of C₁₋₃ alkyl groups and C₁₋₃ hydroxyalkyl groups; and water-soluble sulfoxides containing one linear C₁₀₋₁₈ alkyl moiety and a moiety selected from the group consisting of C₁₋₃ alkyl and C₁₋₃ hydroxyalkyl moieties.

Preferred amine oxide surfactants have formula (VI):

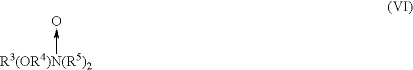

wherein R³ of formula (VI) is a linear C₈₋₂₂ alkyl, linear C₅₋₂₂ hydroxyalkyl, C₈₋₂₂ alkyl phenyl group, and mixtures thereof; R⁴ of formula (VI) is an C₂₋₃ alkylene or C₂₋₃ hydroxyalkylene group or mixtures thereof; x is from 0 to about 3; and each R⁵ of formula (VI) is an C₁₋₃ alkyl or C₁₋₃ hydroxyalkyl group or a polyethylene oxide group containing an average of from about 1 to about 3 ethylene oxide groups. The R⁵ groups of formula (VI) may be attached to each other, e.g., through an oxygen or nitrogen atom, to form a ring structure.

These amine oxide surfactants in particular include C₁₀-C₁₈ alkyl dimethyl amine oxides and C₈-C₁₂ alkoxy ethyl dihydroxy ethyl amine oxides. Preferred amine oxides include C₁₀, C₁₀-C₁₂, and C₁₂-C₁₄ alkyl dimethyl amine oxides.

When present, at least one amine oxide will be present in the liquid detergent composition from about 0.1% to about 15%, more preferably at least about 0.2% to about 12% by weight of the composition. In one embodiment, the amine oxide is present in the liquid detergent composition from about 5% to about 12% by weight of the composition. In another embodiment, the amine oxide is present in the liquid detergent composition from about 3% to about 8% by weight of the composition.

Other suitable, non-limiting examples of amphoteric detergent surfactants that are optional in the present invention include amido propyl betaines and derivatives of aliphatic or heterocyclic secondary and ternary amines in which the aliphatic moiety can be straight chain or branched and wherein one of the aliphatic substituents contains from 8 to 24 carbon atoms and at least one aliphatic substituent contains an anionic water-solubilizing group.

Typically, when present, ampholytic surfactants comprise from about 0.01% to about 20%, preferably from about 0.5% to about 10% by weight of the liquid detergent composition.

The optional presence of magnesium ions may be utilized in the detergent composition when the compositions are used in softened water that contains few divalent ions. When utilized, the magnesium ions preferably are added as a hydroxide, chloride, acetate, sulfate, formate, oxide or nitrate salt to the compositions of the present invention.

When included, the magnesium ions are present at an active level of from 0.01% to 1.5%, preferably from 0.015% to 1%, more preferably from 0.025% to 0.5%, by weight of the liquid detergent composition.

The present liquid detergent compositions may optionally comprise a solvent. Suitable solvents include C₄₋₁₄ ethers and diethers, glycols, alkoxylated glycols, C₆-C₁₆ glycol ethers, alkoxylated aromatic alcohols, aromatic alcohols, aliphatic branched alcohols, alkoxylated aliphatic branched alcohols, alkoxylated linear C₁-C₅ alcohols, linear C₁-C₅ alcohols, amines, C₈-C₁₄ alkyl and cycloalkyl hydrocarbons and halohydrocarbons, and mixtures thereof.

Preferred solvents are selected from methoxy octadecanol, ethoxyethoxyethanol, benzyl alcohol, 2-ethylbutanol and/or 2-methylbutanol, 1-methylpropoxyethanol and/or 2-methylbutoxyethanol, linear C₁-C₅ alcohols such as methanol, ethanol, propanol, isopropanol, butyl diglycol ether (BDGE), butyltriglycol ether, tert-amyl alcohol, glycerol and mixtures thereof. Particularly preferred solvents which can be used herein are butoxy propoxy propanol, butyl diglycol ether, benzyl alcohol, butoxypropanol, propylene glycol, glycerol, ethanol, methanol, isopropanol and mixtures thereof.

Other suitable solvents for use herein include propylene glycol derivatives such as n-butoxypropanol or n-butoxypropoxypropanol, water-soluble CARBITOL R® solvents or water-soluble CELLOSOLVE R® solvents. Water-soluble CARBITOL R® solvents are compounds of the 2-(2-alkoxyethoxy)ethanol class wherein the alkoxy group is derived from ethyl, propyl or butyl; a preferred water-soluble CARBITOL® is 2-(2-butoxyethoxy)ethanol, also known as BUTYL CARBITOL®. Water-soluble CELLOSOLVE R® solvents are compounds of the 2-alkoxyethoxy ethanol class, with 2-butoxyethoxyethanol being preferred. Other suitable solvents include benzyl alcohol, and diols such as 2-ethyl-1,3-hexanediol and 2,2,4-trimethyl-1,3-pentanediol and mixtures thereof. Some preferred solvents for use herein are n-butoxypropoxypropanol, 2-(2butoxyethoxy)ethanol and mixtures thereof.

The solvents can also be selected from the group of compounds comprising ether, derivatives of mono-, di- and tri-ethylene glycol, butylene glycol ethers, and mixtures thereof. The weight average molecular weights of these solvents are preferably less than 350, more preferably between 100 and 300, even more preferably between 115 and 250. Examples of preferred solvents include, for example, mono-ethylene glycol n-hexyl ether, mono-propylene glycol n-butyl ether, and tri-propylene glycol methyl ether. Ethylene glycol and propylene glycol ethers are commercially available from the Dow Chemical Company under the tradename DOWANOL® and from the Arco Chemical Company under the tradename ARCOSOLV®. Other preferred solvents including mono- and di-ethylene glycol n-hexyl ether are available from the Union Carbide Corporation.

When present, the liquid detergent composition will contain 0.01%-20%, preferably 0.5%-20%, more preferably 1%-10% by weight of the liquid detergent composition of a solvent. These solvents may be used in conjunction with an aqueous liquid carrier, such as water, or they may be used without any aqueous liquid carrier being present.

The liquid detergent compositions of the invention may optionally comprise a hydrotrope in an effective amount so that the liquid detergent compositions are appropriately compatible in water. By “appropriately compatible in water”, it is meant that the product dissolves quickly enough in water as dictated by both the washing habit and conditions of use. Products that do not dissolve quickly in water can lead to negatives in performance regarding overall grease and/or cleaning, sudsing, ease of rinsing of product from surfaces such as dishes/glasses etc. or product remaining on surfaces after washing. Inclusion of hydrotropes also serves to improve product stability and formulatibility as is well known in the literature and prior art.

Suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof, and related compounds, as disclosed in U.S. Pat. No. 3,915,903.

The liquid detergent compositions of the present invention typically comprise from 0% to 15% by weight of the liquid detergent composition of a hydrotropic, or mixtures thereof, preferably from 1% to 10%, most preferably from 3% to 6% by weight.

The liquid detergent compositions of the invention may optionally comprise a hydrophobic block polymer having alkylene oxide moieties and a weight average molecular weight of at least 500, but preferably less than 10,000, more preferably from 1000 to 5000 and most preferably from 1500 to 3500. Suitable hydrophobic polymers have a water solubility of less than about 1%, preferably less than about 0.5%, more preferably less than about 0.1% by weight of the polymer at 25° C.

“Block polymers” as used herein is meant to encompass polymers including two or more different homopolymeric and/or monomeric units which are linked to form a single polymer structure. Preferred copolymers comprise ethylene oxide as one of the monomeric units. More preferred copolymers are those with ethylene oxide and propylene oxide. The ethylene oxide content of such preferred polymers is more than about 5 wt %, and more preferably more than about 8 wt %, but less than about 50 wt %, and more preferably less than about 40 wt %. A preferred polymer is ethylene oxide/propylene oxide copolymer available from BASF under the tradename PLURONIC L81® or PLURONIC L43®.

The liquid detergent compositions of the present invention optionally comprise from 0% to 15% by weight of the liquid detergent composition of one or more hydrophobic block polymer(s), preferably from 1% to 10%, most preferably from 3% to 6% by weight.

If the viscosity of the composition is too thin, the liquid detergent compositions herein can also contain from about 0.2% to 5% by weight of the liquid detergent composition of a thickening agent. More preferably, such a thickening agent comprises from about 0.5% to 2.5% of the liquid detergent compositions herein. Thickening agents are typically selected from the class of cellulose derivatives. Suitable thickeners include hydroxy ethyl cellulose, hydroxyethyl methyl cellulose, carboxy methyl cellulose, cationic hydrophobically modified hydroxyethyl cellulose, available from Amerchol Corporation as QUATRISOFT® LM200, and the like. A preferred thickening agent is hydroxypropyl methylcellulose.

The liquid detergent compositions of the present invention may optionally contain a polymeric foam stabilizer. These polymeric suds stabilizers provide extended suds volume and suds duration of the liquid detergent compositions. These polymeric suds stabilizers may be selected from homopolymers of (N,N-dialkylamino) alkyl esters and (N,N-dialkylamino) alkyl acrylate esters. The weight average molecular weight of the polymeric suds boosters, determined via conventional gel permeation chromatography, is from 1,000 to 2,000,000, preferably from 5,000 to 1,000,000, more preferably from 10,000 to 750,000, more preferably from 20,000 to 500,000, even more preferably from 35,000 to 200,000. The polymeric suds stabilizer can optionally be present in the form of a salt, either an inorganic or organic salt, for example the citrate, sulfate, or nitrate salt of (N,N-dimethylamino)alkyl acrylate ester.

One preferred polymeric suds stabilizer is (N,N-dimethylamino)alkyl acrylate esters, namely the acrylate ester represented by the formula (VII):

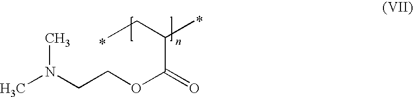

When present in the compositions, the polymeric suds booster may be present in the composition from 0.01% to 15%, preferably from 0.05% to 10%, more preferably from 0.1% to 5%, by weight.

Another optional ingredient of the compositions according to the present invention is a diamine. Since the habits and practices of the users of liquid detergent compositions show considerable variation, the composition will optionally contain 0% to about 15%, preferably about 0.1% to about 15%, preferably about 0.2% to about 10%, more preferably about 0.25% to about 6%, more preferably about 0.5% to about 1.5% by weight of said composition, of at least one diamine.

The liquid detergent compositions according to the present invention may comprise a linear or cyclic carboxylic acid or salt thereof to improve the rinse feel of the composition. The presence of anionic surfactants, especially when present in higher amounts (15-35% by weight of the composition) results in the composition imparting a slippery feel to the hands of the user and the dishware. This feeling of slipperiness is reduced when using the carboxylic acids as defined herein, i.e., the rinse feel becomes draggy.

Carboxylic acids useful herein include C₁₋₆ linear or at least 3 carbon containing cyclic acids. The linear or cyclic carbon-containing chain of the carboxylic acid or salt thereof may be substituted with a substituent group selected from the group consisting of hydroxyl, ester, ether, aliphatic groups having from 1 to 6, more preferably 1 to 4 carbon atoms, and mixtures thereof.

Preferred carboxylic acids are those selected from the group consisting of salicylic acid, maleic acid, acetyl salicylic acid, 3 methyl salicylic acid, 4 hydroxy isophthalic acid, dihydroxyfumaric acid, 1,2,4-benzene tricarboxylic acid, pentanoic acid, salts thereof, and mixtures thereof. Where the carboxylic acid exists in the salt form, the cation of the salt is preferably selected from alkali metal, alkaline earth metal, monoethanolamine, diethanolamine, triethanolamine, and mixtures thereof.

The carboxylic acid or salt thereof, when present, is preferably present at the level of from 0.1% to 5%, more preferably from 0.2% to 1% and most preferably from 0.25% to 0.5%.

The compositions according to the present invention may further comprise a builder system. If it is desirable to use a builder, then any conventional builder system is suitable for use herein including aluminosilicate materials, silicates, polycarboxylates and fatty acids, materials such as ethylenediamine tetraacetate, metal ion sequestrants, such as aminopolyphosphonates, particularly ethylenediamine tetramethylene phosphonic acid and diethylene triamine pentamethylene-phosphoric acid. Phosphate builders can also be used.

Suitable polycarboxylates builders for use herein include citric acid, preferably in the form of a water-soluble salt, derivatives of succinic acid of the formula (VIII) R—CH(COOH)CH₂(COOH) wherein R of formula (VIII) is C₁₀₋₂₀ alkyl or alkenyl, preferably C₁₂₋₁₆, or wherein R of formula (VIII) can be substituted with hydroxyl, sulfa sulfoxyl or sulfone substituents. Specific examples include lauryl succinate, myristyl succinate, palmityl succinate 2-dodecenylsuccinate, 2-tetradecenyl succinate. Succinate builders are preferably used in the form of their water-soluble salts, including sodium, potassium, ammonium and alkanolammonium salts.

Other suitable polycarboxylates are oxodisuccinates and mixtures of tartrate monosuccinic and tartrate disuccinic acid such as described in U.S. Pat. No. 4,663,071.

Suitable fatty acid builders for use herein are saturated or unsaturated C₁₀₋₁₈ fatty acids, as well as the corresponding soaps. Preferred saturated species have from 12 to 16 carbon atoms in the alkyl chain. The preferred unsaturated fatty acid is oleic acid. Other preferred builder system for liquid compositions is based on dodecenyl succinic acid and citric acid.

If detergency builder salts are included, they may be included in amounts of from 0.5% to 50% by weight of the composition, preferably from 0.5% to 25%, and more preferably from 0.5% to 5% by weight of the liquid detergent composition.

Detergent compositions of the present invention optionally may further comprise one or more enzymes which provide cleaning performance benefits. Said enzymes include enzymes selected from cellulases, hemicellulases, peroxidases, proteases, gluco-amylases, amylases, lipases, cutinases, pectinases, xylanases, reductases, oxidases, phenoloxidases, lipoxygenases, ligninases, pullulanases, tannases, pentosanases, malanases, β-glucanases, arabinosidases or mixtures thereof.

A preferred combination is a detergent composition having a mixture of conventional applicable enzymes, like protease, amylase, lipase, cutinase, and/or cellulase enzymes. Enzymes, when present, are in the compositions at from 0.0001% to 5% of active enzyme, by weight of the detergent composition. Preferred proteolytic enzymes, then, are selected from the group consisting of SAVINASE®; MAXATASE®; MAXACAL®; MAXAPEM 15®; subtilisin BPN and BPN; Protease B; Protease A; Protease D (Genencor); PRIMASE®; DURAZYM®; OPTICLEAN®; and OPTIMASE®; and ALCALASE® (Novo Industri A/S), and mixtures thereof. Protease B is most preferred. Preferred amylase enzymes include TERMAMYL®, DURAMYL® and the amylase enzymes those described in WO 94/18314 and WO 94/02597.

The detergent compositions herein may also optionally contain one or more iron and/or manganese chelating agents. Such chelating agents can be selected from the group consisting of amino carboxylates, amino phosphonates, polyfunctionally-substituted aromatic chelating agents and mixtures therein, all as hereinafter defined.

Amino carboxylates useful as optional chelating agents include ethylene diamine tetracetates, N-hydroxy ethyl ethylenediamine triacetates, nitrilo-tri-acetates, ethylenediamine tetraproprionates, triethylene tetraamine hexacetates, diethylene triamine pentaacetates, and ethanol diglycines, alkali metal, ammonium, and substituted ammonium salts therein and mixtures therein.

Aminophosphonates are also suitable for use as chelating agents in the compositions of the invention, and include ethylenediamine tetrakis (methylene phosphonates) available under the tradename DEQUEST®. Aminophosphonates that do not contain alkyl or alkenyl groups with more than 6 carbon atoms are preferred. Polyfunctionally-substituted aromatic chelating agents are also useful in the liquid detergent compositions herein, preferably in acid form. See U.S. Pat. No. 3,812,044. Preferred compounds include dihydroxydisulfobenzenes, such as 1,2-dihydroxy-3,5-disulfobenzene. A preferred biodegradable chelator for use herein is ethylenediamine disuccinate (“EDDS”), especially the [S,S] isomer as described in U.S. Pat. No. 4,704,233. The liquid detergent compositions herein may also contain water-soluble methyl glycine diacetic acid (MGDA) salts (or acid form) as a chelant or co-builder. Similarly, the so called “weak” builders such as citrate can also be used as chelating agents.

If utilized, chelating agents may comprise from 0.00015% to 15% by weight of the liquid detergent compositions herein. More preferably, if utilized, the chelating agents will comprise from 0.0003% to 3.0% by weight of such compositions.

Preferably, the liquid detergent compositions herein are formulated as clear liquid compositions. By “clear” it is meant transparent. Preferred liquid detergent compositions in accordance with the invention are clear single phase liquids, but the invention also embraces clear and opaque products containing dispersed phases, such as beads or pearls as described in U.S. Pat. No. 5,866,529, and U.S. Pat. No. 6,380,150.

The liquid detergent compositions of the present invention may be packages in any suitable packaging for delivering the liquid detergent composition for use. Preferably the package is a clear package made of glass or plastic.

The liquid detergent compositions herein can further comprise a number of other optional ingredients suitable for use in liquid detergent compositions such as perfume, dyes, opacifiers, and pH buffering means so that the liquid detergent compositions herein generally have a pH of from 4 to 14, preferably 6 to 13, most preferably 6 to 10. A further discussion of acceptable optional ingredients suitable for use in liquid detergent compositions, specifically light-duty liquid detergent composition may be found in U.S. Pat. No. 5,798,505.

In the method aspect of this invention, soiled dishes are contacted with an effective amount, typically from about 0.5 mL to about 20 mL (per 25 dishes being treated), preferably from about 3 mL to about 10 mL, of the liquid detergent composition of the present invention diluted in water. The actual amount of liquid detergent composition used will be based on the judgment of user, and will typically depend upon factors such as the particular product formulation of the composition, including the concentration of active ingredients in the composition, the number of soiled dishes to be cleaned, the degree of soiling on the dishes, and the like. The particular product formulation, in turn, will depend upon a number of factors, such as the intended market (i.e., U.S., Europe, Japan, etc.) for the composition product.

Generally, from about 0.01 mL to about 150 mL, preferably from about 3 mL to about 40 mL of a liquid detergent composition of the invention is combined with from about 2000 mL to about 20000 mL, more typically from about 5000 mL to about 15000 mL of water in a sink. The soiled dishes are immersed in the sink containing the diluted compositions, and contacting the soiled surface of the dish with a cloth, sponge, or similar article. The cloth, sponge, or similar article may be immersed in the detergent composition and water mixture prior to being contacted with the dish surface, and is typically contacted with the dish surface for a period of time ranged from about 1 to about 10 seconds, although the actual time will vary with each application and user. The contacting of cloth, sponge, or similar article to the dish surface is preferably accompanied by a concurrent scrubbing of the dish surface.

Another method of use will comprise immersing the soiled dishes into a water bath without any liquid dishwashing detergent. A device for absorbing liquid dishwashing detergent, such as a sponge, is placed directly into a separate quantity of undiluted liquid dishwashing composition for a period of time typically ranging from about 1 to about 5 seconds. The absorbing device, and consequently the undiluted liquid dishwashing composition, then contacts individually the surface of each soiled dish to remove said soiling. The absorbing device is typically contacted with each dish surface for a period of time range from about 1 to about 10 seconds, although the actual time of application will be dependent upon factors such as the degree of soiling of the dish. The contacting of the absorbing device to the dish surface is preferably accompanied by concurrent scrubbing.

### Automatic Dishwasher Detergent

As used herein, the term “dish” or “dishes” means any tableware (plates, bowls, glasses, mugs), cookware (pots, pans, baking dishes), glassware, silverware or flatware and cutlery, cutting board, food preparation equipment, etc. which is washed prior to or after contacting food, being used in a food preparation process and/or in the serving of food.

With reference to the polymers described herein, the term weight-average molecular weight is the weight-average molecular weight as determined using gel permeation chromatography according to the protocol found in Colloids and Surfaces A. Physico Chemical & Engineering Aspects, Vol. 162, 2000, pg. 107-121. The units are Daltons.

It should be understood that every maximum numerical limitation given throughout this specification would include every lower numerical limitation, as if such lower numerical limitation was expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The bulk density of the granular detergent compositions in accordance with the present invention is typically of at least 0.9 g/cm³, more usually at least 0.95 g/cm³ and more preferably from 0.95 g/cm³ to about 1.2 g/cm³.

Bulk density is measured by means of a simple funnel and cup device consisting of a conical funnel molded rigidly on a base and provided with a flap valve at its lower extremity to allow the contents of the funnel to be emptied into an axially aligned cylindrial cup disposed below the funnel. The funnel is 130 mm and 40 mm at its respective upper and lower extremities. It is mounted so that the lower extremity is 140 mm above the upper surface of the base. The cup has an overall height of 90 mm, internal height of 87 mm and an internal diameter of 84 mm. Its nominal volume is 500

To carry out a measurement, the funnel is filled with powder by hand pouring, the flap valve is opened and powder allowed to overfill the cup. The filled cup is removed from the frame and excess powder removed from the cup by passing a straight edged implement e.g., a knife, across its upper edge. The filled cup is then weighed and the value obtained for the weight of powder doubled to provide the bulk density in g/cm³. Replicate measurements are made as required.

The particle size of the components of granular compositions in accordance with the invention should preferably be such that no more that 5% of particles are greater than 1.4 mm in diameter and not more than 5% of particles are less than 0.15 mm in diameter.

The present composition comprises from about 0.1 wt % to about 20 wt %, from about 1 wt % to about 15 wt %, from about 1 wt % to about 10 wt %, by weight of the automatic dishwashing detergent of a polymer dispersant.

Suitable polymer dispersants are generally at least partially neutralized in the form of their alkali metal, ammonium or other conventional cation salts. The alkali metals, especially sodium salts, are most preferred. While the weight average molecular weight of such dispersants can vary over a wide range, it preferably is from about 1,000 to about 500,000, more preferably is from about 2,000 to about 250,000, and most preferably is from about 3,000 to about 100,000. Nonlimiting examples of such materials are as follows. Sodium polyacrylate having a nominal molecular weight of about 4500, obtainable from Rohm & Haas under the tradename as ACUSOL® 445N, or acrylate/maleate copolymers such as are available under the tradename SOKALAN®, from BASF Corp., are preferred dispersants herein. The polymer dispersant commercially available under the trade name of SOKALAN® CP45 is a partially neutralized copolymer of methacrylic acid and maleic anhydride sodium salt is also suitable for use herein.

Other suitable polymer dispersants for use herein are polymers containing both carboxylate and sulphonate monomers, such as ALCOSPERSE® polymers (supplied by Alco).

Water-soluble nonphosphate salts are typically materials which are moderately alkaline or, in any event, not highly alkaline, e.g., not materials such as pure sodium hydroxide or sodium metasilicate, although small amounts of such highly alkaline materials can be co-present with other salts. Salts useful herein include, for example, sodium carbonate, sodium citrate and mixtures thereof. Bicarbonate salts are not included in the compositions herein. Those familiar with the art of agglomeration will appreciate that physical modifications of the salts, e.g., to achieve increased surface area or more desirable particle shape, can be useful for improving the agglomeration characteristics.

The composition should be substantially free of bicarbonate salts. As used herein “substantially free” means that bicarbonate salts should be present at levels less than 1 wt % by weight of the composition. Preferably from 0 wt % to about 0.9 wt % by weight of the composition.

Preferred inorganic nonphosphate builder salts useful herein are the carbonate builders. Especially preferred by way of carbonate builder is anhydrous sodium carbonate, which, although it acts as a precipitating builder, is freely usable; for example, when present at levels of from about 10 wt % to about 80 wt % of the automatic dishwashing composition, preferably from about 10 wt % to about 60 wt % by weight of the automatic dishwashing composition. In one embodiment the weight ratio fo carbonate salts to polymer dispersant is from about 20:1 to about 6:1. Water-soluble sulfate salts may be optionally be present from about 0.05 wt % to about 50 wt % by weight of the automatic dishwashing composition.

Other suitable water-soluble nonphosphate salts herein are the citrates salt including, especially preferred are the sodium citrates, such as disodium citrate dihydrate. However, in one embodiment, the composition is substantially free of citrate salts. As used herein “substantially free” means that the citrate salts should be present at levels less than 1 wt % by weight of the composition, preferably from 0 wt % to about 0.9 wt % by weight of the composition.

The present compositions will typically comprise from about 10 wt % to about 99 wt %, preferably from about 10 wt % to about 90 wt %, preferably from about 10 wt % to about 75 wt % by weight of the composition of the water soluble nonphosphorus salts.

The compositions of this invention may contain up to about 20 wt %, preferably from about 2 wt % to about 15 wt %, preferably from about 4 wt % to about 14 wt %, by weight of the automatic dishwashing composition of SiO₂ as a mixture of sodium or potassium silicates, preferably sodium silicates. These alkali metal silicate solids normally comprise from about 10 wt % to about 20 wt % of the composition. One ratio (1.0r) to 3.6r silicates can be used although lower ratio silicates should be limited. A suitable silicate mixture is disclosed in U.S. Pat. No. 4,199,467.

From about 0 wt % to about 10 wt %, most preferably from about 2 wt % to about 8 wt % by weight of the formula is silicate solids from a hydrous silicate having a weight ratio of SiO₂:M₂O (M=Na or K) of from about 2 to about 3.2, preferably 2.4. This hydrous silicate at the indicated levels provides SiO₂ and can provide a desirable balance between agglomerating characteristics and the ability to form free-flowing, non-caking agglomerates while avoiding formation of excessive insolubles in certain formulas.

Lower moisture levels in general are desirable, e.g., it helps to use high solids levels wet silicates. It is also desirable to use as much of the two ratio (2.0r) silicate as possible for the remainder of the silicate, which can also be a mixture of 2.0r and 3.0r to 3.6r silicates, for best overall performance as far as spotting and filming (S/F) is concerned on metal surfaces, as disclosed in U.S. Pat. No. 4,199,468.

Any suitable adjunct ingredient in any suitable amount or form may be used. For an example, a detergent active and/or rinse aid active, adjuvant, and/or additive, may be used in combination the corrosion inhibitor. Suitable adjunct ingredients include, but are not limited to, cleaning agents, surfactant other than the nonionic surfactants discussed above for example, anionic, cationic, amphoteric, zwitterionic, and mixtures thereof, chelating agent/sequestrant blend, bleaching system (for example, chlorine bleach, oxygen bleach, bleach activator, bleach catalyst, and mixtures thereof), enzyme (for example, a protease, lipase, amylase, and mixtures thereof), alkalinity source, water softening agent, secondary solubility modifier, thickener, acid, soil release polymer, dispersant polymer, thickeners, hydrotrope, binder, carrier medium, antibacterial active, detergent filler, abrasive, suds suppressor, defoamer, anti-redeposition agent, threshold agent or system, aesthetic enhancing agent (i.e., dye, colorants, perfume, etc.), oil, solvent, and mixtures thereof.

The methods described herein may use a composition comprising one or more suitable surfactants, optionally in a surfactant system, in any suitable amount or form. Suitable surfactants include anionic surfactants, cationic surfactants, nonionic surfactants, amphoteric surfactants, ampholytic surfactants, zwitterionic surfactants, and mixtures thereof. For example, a mixed surfactant system may comprise one or more different types of the above-described surfactants.

In one embodiment, the composition is substantially free of surfactants. As used herein “substantially free” means that surfactants should be present at levels less than 0.5 wt % by weight of the composition. Preferably from 0 wt % to about 0.4 wt % by weight of the composition.

Suitable nonionic surfactants also include, but are not limited to low-foaming nonionic (LFNI) surfactants. A LFNI surfactant is most typically used in an automatic dishwashing composition because of the improved water-sheeting action (especially from glassware) which they confer to the automatic dishwashing composition. They also may encompass non-silicone, phosphate or nonphosphate polymeric materials which are known to defoam food soils encountered in automatic dishwashing. The LFNI surfactant may have a) relatively low cloud point and a high hydrophilic-lipophilic balance (HLB). Cloud points of 1% solutions in water are typically below about 32° C. and alternatively lower, e.g., 0° C., for optimum control of sudsing throughout a full range of water temperatures. If desired, a biodegradable LFNI surfactant having the above properties may be used.

A LFNI surfactant may include, but is not limited to: alkoxylated surfactants, especially ethoxylates derived from primary alcohols, and blends thereof with more sophisticated surfactants, such as the polyoxypropylene/polyoxyethylene/polyoxypropylene reverse block polymers. Suitable block polyoxyethylene/polyoxypropylene polymeric compounds that meet the requirements may include those based on ethylene glycol, propylene glycol, glycerol, trimethylolpropane and ethylenediamine, and mixtures thereof. Polymeric compounds made from a sequential ethoxylation and propoxylation of initiator compounds with a single reactive hydrogen atom, such as C₁₂₋₁₈ aliphatic alcohols, do not generally provide satisfactory suds control in Automatic dishwashing compositions. However, certain of the block polymer surfactant compounds designated as PLURONIC® and TETRONIC® by the BASF-Wyandotte Corp., Wyandotte, Mich., are suitable in Automatic dishwashing compositions.

The LFNI surfactant can optionally include a propylene oxide in an amount up to about 15% by weight. Other LFNI surfactants can be prepared by the processes described in U.S. Pat. No. 4,223,163. The LFNI surfactant may also be derived from a straight chain fatty alcohol containing from about 16 to about 20 carbon atoms (C₁₆-C₂₀ alcohol), alternatively a C₁₈ alcohol, condensed with an average of from about 6 to about 15 moles, or from about 7 to about 12 moles, and alternatively, from about 7 to about 9 moles of ethylene oxide per mole of alcohol. The ethoxylated nonionic surfactant so derived may have a narrow ethoxylate distribution relative to the average.

In certain embodiments, a LFNI surfactant having a cloud point below 30° C. may be present in an amount from about 0.01% to about 10%, or from about 0.5% to about 8% by weight, and alternatively, from about 1% to about 5% by weight of the composition.

Suitable anionic surfactants for use herein include, but are not limited to: alkyl sulfates, alkyl ether sulfates, alkyl benzene sulfonates, alkyl glyceryl sulfonates, alkyl and alkenyl sulphonates, alkyl ethoxy carboxylates, N-acyl sarcosinates, N-acyl taurates and alkyl succinates and sulfosuccinates, wherein the alkyl, alkenyl or acyl moiety is C₅-C₂₀, or C₁₀-C₁₈ linear or branched. Suitable cationic surfactants include, but are not limited to: chlorine esters and mono C₆-C₁₆ N-alkyl or alkenyl ammonium surfactants, wherein the remaining N positions are substituted by methyl, hydroxyethyl or hydroxypropyl groups. Suitable nonionic surfactants include, but are not limited to: low and high cloud point surfactants, and mixtures thereof. Suitable amphoteric surfactants include, but are not limited to: the C₁₂-C₂₀ alkyl amine oxides (for example, lauryldimethyl amine oxide and hexadecyl dimethyl amine oxide), and alkyl amphocarboxylic surfactants, such as MIRANOL® C2M. Suitable zwitterionic surfactants include, but are not limited to: betaines and sultaines; and mixtures thereof. Surfactants suitable for use are disclosed, for example, in U.S. Pat. No. 3,929,678; U.S. Pat. No. 4,223,163; U.S. Pat. No. 4,228,042; U.S. Pat. No. 4,239,660; U.S. Pat. No. 4,259,217; U.S. Pat. No. 4,260,529; and U.S. Pat. No. 6,326,341; EP 0414 549, EP 0,200,263, WO 93/08876 and WO 93/08874.

In one embodiment, particulate zinc-containing materials (PZCMs) and zinc-containing layered materials (ZCLMs), for treating glassware surfaces may be added as adjunct ingredients. Particulate zinc-containing materials (PZCMs) remain mostly insoluble within formulated compositions. Examples of PZCMs useful in certain non-limiting embodiments may include the following: inorganic material such as zinc aluminate, zinc carbonate, zinc oxide and materials containing zinc oxide (i.e., calamine), zinc phosphates (i.e., orthophosphate and pyrophosphate), zinc selenide, zinc sulfide, zinc silicates (i.e., ortho- and meta-zinc silicates), zinc silicofluoride, zinc borate, zinc hydroxide and hydroxy sulfate, and ZCLMs. PZCMs as glass corrosion protection agents require that the Zn²⁺ ion be chemically available without being soluble.

Many ZCLMs occur naturally as minerals. Common examples include hydrozincite (zinc carbonate hydroxide), basic zinc carbonate, aurichalcite (zinc copper carbonate hydroxide), rosasite (copper zinc carbonate hydroxide) and many related minerals that are zinc-containing. Natural ZCLMs can also occur wherein anionic layer species such as clay-type minerals (e.g., phyllosilicates) contain ion-exchanged zinc gallery ions. Other suitable ZCLMs include the following: zinc hydroxide acetate, zinc hydroxide chloride, zinc hydroxide lauryl sulfate, zinc hydroxide nitrate, zinc hydroxide sulfate, hydroxy double salts, and mixtures thereof. Natural ZCLMs can also be obtained synthetically or formed in situ in a composition or during a production process.

Commercially available sources of zinc carbonate include zinc carbonate basic (Cater Chemicals: Bensenville, Ill., USA), zinc carbonate (Shepherd Chemicals: Norwood, Ohio, USA), zinc carbonate (CPS Union Corp.: New York, N.Y., USA), zinc carbonate (Elementis Pigments: Durham, UK), and zinc carbonate AC (Bruggemann Chemical: Newtown Square, Pa., USA).

Any suitable PZCM or more particularly ZCLM in any suitable amount may be used. Suitable amounts of a PZCM include, but are not limited to: a range from about 0.001% to about 20%, or from about 0.001% to about 10%, or from about 0.01% to about 7%, and alternatively, from about 0.1% to about 5% by weight of the composition.

Any suitable suds suppressor in any suitable amount or form may be used. Suds suppressors suitable for use may be low foaming and include low cloud point nonionic surfactants (as discussed above) and mixtures of higher foaming surfactants with low cloud point nonionic surfactants which act as suds suppressors therein (see WO 93/08876; EP 0 705 324, U.S. Pat. No. 6,593,287, U.S. Pat. No. 6,326,341 and U.S. Pat. No. 5,576,281.

Suitable suds suppressor can be selected from the group consisting of silicon based antifoams, particularly conventional inorganic-filled polydimethylsiloxane antifoam agents, especially silica-filled polydimethylsiloxane antifoam agents as disclosed in U.S. Pat. No. 4,639,489 and U.S. Pat. No. 3,455,839. These and other suitable suds suppressor are commercially available under the tradenames of SILCOLAPSE® 431 and SILICONE EP® 6508 from ICI United States Inc., Wilmington, Del., U.S.A., RHODOSIL® 454 from RhonePoulenc Chemical Co., Monmouth Junction, N.J., U.S.A.; and SILKONOL AK® 100 commercially available from Wacker-Chemie G.m.b.H., Munich, Federal Republic of Germany.

In certain embodiments, one or more suds suppressors may be present in an amount from about 0% to about 30% by weight, or about 0.2% to about 30% by weight, or from about 0.5% to about 10%, and alternatively, from about 1% to about 5% by weight of the automatic dishwashing composition.

Any suitable enzyme and/or enzyme stabilizing system in any suitable amount or form may be used. Enzymes suitable for use include, but are not limited to: proteases, amylases, lipases, cellulases, peroxidases, and mixtures thereof. Amylases and/or proteases are commercially available with improved bleach compatibility. In practical terms, the composition may comprise an amount up to about 5 mg, more typically about 0.01 mg to about 3 mg by weight, of active enzyme per gram of the composition. Protease enzymes are usually present in such commercial preparations at levels sufficient to provide from 0.005 to 0.1 Anson units (AU) of activity per gram of composition, or 0.01%-1% by weight of a commercial enzyme preparation.

In certain embodiments, enzyme-containing compositions, may comprise from about 0.0001% to about 10%; from about 0.005% to about 8%; from about 0.01% to about 6%, by weight of the composition of an enzyme stabilizing system. The enzyme stabilizing system can be any stabilizing system that is compatible with the detersive enzyme. Such stabilizing systems can include, but are not limited to: calcium ions, boric acid, propylene glycol, short chain carboxylic acid, boronic acid, and mixtures thereof.

Any suitable bleaching agent or system in any suitable amount or form may be used. Bleaching agents suitable for use include, but are not limited to: chlorine and oxygen bleaches. In certain embodiments, a bleaching agent or system may be present in an amount from about 0% to about 30% by weight, or about 1% to about 25% by weight, or from about 1% to about 20% by weight, and alternatively from about 2% to about 6% by weight of the composition.

Suitable bleaching agents include, but are not limited to: inorganic chlorine (such as chlorinated trisodium phosphate), organic chlorine bleaches (such as chlorocyanurates, water-soluble dichlorocyanurates, sodium or potassium dichloroisocyanurate dihydrate, sodium hypochlorite and other alkali metal hypochlorites); inorganic perhydrate salts (such as sodium perborate mono- and tetrahydrates and sodium percarbonate, which may be optionally coated to provide controlled rate of release as disclosed in GB 1466799 on sulfate/carbonate coatings), preformed organic peroxyacids, and mixtures thereof.

Peroxygen bleaching compounds can be any peroxide source comprising sodium perborate monohydrate, sodium perborate tetrahydrate, sodium pyrophosphate peroxyhydrate, urea peroxyhydrate, sodium percarbonate, sodium peroxide, and mixtures thereof. In other non-limiting embodiments, peroxygen-bleaching compounds may comprise sodium perborate monohydrate, sodium perborate tetrahydrate, sodium percarbonate, and mixtures thereof.

The bleaching system may also comprise transition metal-containing bleach catalysts, bleach activators, and mixtures thereof. Bleach catalysts suitable for use include, but are not limited to: the manganese triazacyclononane and related complexes (see U.S. Pat. No. 4,246,612, U.S. Pat. No. 5,227,084); Co, Cu, Mn and Fe bispyridylamine and related complexes (see U.S. Pat. No. 5,114,611); and pentamine acetate cobalt (III) and related complexes (see U.S. Pat. No. 4,810,410) at levels from 0% to about 10.0%, by weight; and alternatively, from about 0.0001% to about 1.0% by weight of the composition.

Typical bleach activators suitable for use include, but are not limited to: peroxyacid bleach precursors, precursors of perbenzoic acid and substituted perbenzoic acid; cationic peroxyacid precursors; peracetic acid precursors, such as TAED, sodium acetoxybenzene sulfonate and pentaacetylglucose; pernonanoic acid precursors such as sodium 3,5,5-trimethylhexanoyloxybenzene sulfonate (iso-NOBS) and sodium nonanoyloxybenzene sulfonate (NOBS); amide substituted alkyl peroxyacid precursors (EP 0 170 386); and benzoxazin peroxyacid precursors (EP 0 332 294 and EP 0 482 807) at levels from 0% to about 10.0%, by weight; or from 0% to about 6%, by weight or from 0.1% to 1.0% by weight of the composition.

The detergent compositions of the present invention are not restricted as to manner of preparation. The granular compositions can be prepared in any manner that results information of a granular product form, preferably by agglomeration. The process described in U.S. Pat. No. 2,895,916, and variations thereof, are particularly suitable. Also particularly suitable is the process described in U.S. Pat. No. 5,614,485, U.S. Pat. No. 4,427,417 U.S. Pat. No. 5,914,307, U.S. Pat. No. 6,017,873 and U.S. Pat. No. 4,169,806.

The composition described herein, can be used for the cleaning of soiled dishes by contacting the composition with a dish surface and then rinsing the dish surface with water. Optionally the dishes are allowed to dry either by heat or by air drying. Preferably the dishes are placed into an automatic dishwashing unit. The automatic dishwashing composition suitable herein can be dispensed from any suitable device, including but not limited to: dispensing baskets or cups, bottles (pump assisted bottles, squeeze bottles, etc.), mechanic pumps, multi-compartment bottles, capsules, multi-compartment capsules, paste dispensers, and single and multi-compartment water-soluble pouches, and combinations thereof. For example, a multi-phase tablet, a water-soluble or water-dispersible pouch, and combinations thereof, may be used to deliver the composition to the desired dish surface.

### Car Cleaning Composition

The cleaning composition can be any suitable composition that is capable of cleaning the surface in issue. Preferably, the cleaning composition leaves the surface as free from residue as possible. In certain preferred embodiments, the cleaning composition is capable of rendering the surface hydrophilic. By the term “hydrophilic”, it is meant that the surface has a high affinity for water. Because of the affinity between water and the surface, water spreads out on the surface to maximize contact. The higher the hydrophilicity, the greater the spread and the smaller the contact angle. Hydrophilicity can be determined by measuring the contact angle between the surface and a droplet of water on the surface. Contact angle is measured according to the American Standard Test Method for measuring contact angle, designation number D5725-95 using the apparatus commercially sold under the trade name Contact Angle Measuring System G10 by Kruss USA, Charlotte, N.C., USA.

In a preferred embodiment of the present invention, the surface after treatment with the cleaning composition has a contact angle of less than or equal to about 80°, or a contact angle less than or equal to any number of degrees less than 80° (all of which numbers are incorporated herein even though not specifically listed herein, for example, 40°, 30°, 20°, etc.) with the lower contact angles being more preferred.

In one non-limiting embodiment, the cleaning composition comprises a polymer which is capable of rendering the surface cleaned hydrophilic. The polymer should be a “surface substantive polymer” meaning that it is capable of modifying the surface by adhering or in some way associating with the surface to be cleaned such that it preferably remains on the surface during and after the cleaning process. Such adhesion or association may be for example by: covalent interaction; electrostatic interaction; hydrogen bonding; or Van der Waals forces. The polymer modifies the surface by rendering it hydrophilic. In a preferred version of such an embodiment, the polymer is preferably also capable of semi-durably modifying the surface to render it hydrophilic. By “semi-durably” it is meant that the hydrophilic surface modification is maintained for at least one rinse with water.

The polymer used in these embodiments of the cleaning composition may be a homo or copolymer. Preferably, the polymer comprises at least one hydrophobic or cationic moiety and at least one hydrophilic moiety. The hydrophobic moiety is preferably aromatic, C₈₋₁₈ linear or branched carbon chain, vinyl imidazole or a propoxy group. Cationic moieties include any group that is positively charged or has a positive dipole. The hydrophilic moiety may be selected from any moiety that forms a dipole which is capable of hydrogen bonding. Suitable examples of such hydrophilic moieties include vinyl pyrrolidone, carboxylic acid, such as acrylic acid, methacrylic acid, maleic acid, and ethoxy groups.

In certain non-limiting embodiments of the invention, water soluble or water dispersible polymers are used in the cleaning composition to hydrophilically modify the surface. Water soluble polymers and copolymers may include those in which at least one non-limiting embodiments of the invention, water soluble or water segment or group of the polymer comprises functionality that serves to modify or enhance the hydrophilicity of the polymer or the adsorption of the polymer to the surface. Examples of the hydrophilizing segments or groups include: water soluble polyethers; water soluble polyhydroxylated groups or polymers, including saccharides and polysaccharides; water soluble carboxylates and polycarboxylates; water soluble anionic groups such as carboxylates, sulfonates, sulfates, phosphates, phosphonates and polymers thereof; water soluble amines, quaternaries, amine oxides, pyrrolidone, and polymers thereof; water soluble zwitterionic groups and polymers thereof, water soluble amides and polyamides; and water soluble polymers and copolymers of vinylimidazole and vinylpyrrolidone. Additionally, the water soluble polymer may include quaternized vinylpyrrolidone/dialkylaminoalkyl acrylate or methacrylate copolymers. Examples of the adsorption enhancing segment or group include but are not limited to the following: the segment or group of the polymer that comprises functionality that serves to modify or enhance the hydrophilicity, or segments or groups that include: aromatic, C₈₋₁₈ linear or branched carbon chains, vinyl imidazole or a propoxy group, alkylene, and aryl groups, and polymeric aliphatic or aromatic hydrocarbons; fluorocarbons and polymers comprising fluorocarbons; silicones; hydrophobic polyethers such as poly(styrene oxide), polypropylene oxide), poly(butene oxide), poly(tetramethylene oxide), and poly(dodecyl glycidyl ether); and hydrophobic polyesters such as polycaprolactone and poly(3-hydroxycarboxylic acids).

In certain non-limiting, but preferred embodiments, the polymer is selected from the group consisting of copolymers of polyvinyl pyrrolidone. A particularly preferred copolymer of polyvinyl pyrrolidone is N-vinylimidazole N-vinylpyrrolidone (PVPVI) polymers available from for example BASF under the trade name LUVITECT™ VP155K18P. Preferred PVPVI polymers have an average molecular weight of from about 1,000 to about 5,000,000, more preferably from about 5,000 to about 2,000,000, even more preferably from about 5,000 to about 500,000 and most preferably from about 5,000 to about 15,000. Preferred PVPVI polymers comprise at least about 55%, preferably at least about 60% N-vinylimidazole monomers. Alternatively, another suitable polymer may be a quaternized PVPVI, for example, the compound sold under the tradename LUVITEC™ Quat 73W by BASF.

Other suitable copolymers of vinylpyrrolidone for use in the cleaning composition are quaternized vinylpyrrolidone/dialkylaminoalkyl acrylate or methacrylate copolymers. The quaternized vinylpyrrolidone/dialkylaminoalkyl acrylate or methacrylate copolymers suitable for use in the cleaning composition have the following formula:

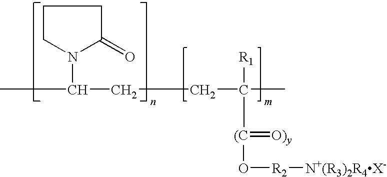

in which n is between 20 and 99 and preferably between 40 and 90 mol % and m is between 1 and 80 and preferably between 5 and 40 mol %; R₁ represents H or CH₃; y denotes 0 or 1; R₂ is —CH₂—CHOH—CH₂— or CₓH₂ₓ, in which x=2 to 18; R₃ represents a lower alkyl group of from 1 to 4 carbon atoms, preferably methyl or ethyl, or

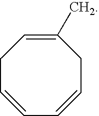

R₄ denotes a lower alkyl group of from 1 to 4 carbon atoms, preferably methyl or ethyl; X″ is chosen from the group consisting of Cl, Br, I, ½SO₄, HSO₄ and CH₃SO₃. The polymers can be prepared by the process described in French Pat. Nos. 2,077,143 and 2,393,573.

The preferred quaternized vinylpyrrolidone/dialkylaminoalkyl acrylate or methacrylate copolymers for use in the cleaning composition have a molecular weight of between about 1,000 and about 1,000,000, preferably between about 10,000 and about 500,000 and more preferably between about 10,000 and about 100,000. The average molecular weight range is determined by light scattering as described in Barth H. G. and Mays J. W. Chemical Analysis Vol 113, “Modern Methods of Polymer Characterization”. Such vinylpyrrolidone/dialkylaminoalkyl acrylate or methacrylate copolymers are commercially available under the name copolymer 845®, GAFQUAT 734®, or GAFQUAT 755® from ISP Corporation, New York, N.Y. and Montreal, Canada or from BASF under the tradename LUVIQUAT®. Also preferred herein are quaternized copolymers of vinyl pyrrolidone and dimethyl aminoethymethacrylate (polyquaternium-11) available from BASF. Another preferred polymer is polyvinyl pyridine N-oxide (PVNO) polymer available from, for example Reilly. Preferred PVNO polymers have an average molecular weight of about 1,000 to about 2,000,000, more preferably from about 5,000 to about 500,000, most preferably from about 15,000 to about 50,000. The polymer is preferably present in the cleaning composition at a level of from about 0.001% to about 10%, more preferably about 0.01% to about 5%, most preferably about 0.01% to about 1% by weight of the cleaning composition.

The cleaning composition may comprise a variety of optional ingredients depending on the desired benefit and the type of surface to be cleaned. Suitable optional ingredients for use herein can be selected from the group comprising: anti-resoiling ingredients, surfactants, clay, chelating agents, enzymes, hydrotopes, ions, suds control agents, solvents, buffers, thickening agents, radical scavengers, soil suspending polymers, pigments, dyes, preservatives and/or perfumes. Suitable ingredients for the cleaning compositions, particularly surfactants therefore, are described in U.S. Pat. No. 5,888,955, U.S. Pat. No. 6,172,021, and U.S. Pat. No. 6,281,181. The cleaning composition may (or may not) include other ingredients, such as those specified below for the treating composition (including, but not limited to nanoparticles).

The cleaning composition may be in any form, for example, liquid, gel, foam, particulate or tablet. When the cleaning composition is a liquid, it may be aqueous or non-aqueous, dilute or concentrated. When the cleaning composition is aqueous, it preferably comprises from about 1% to about 99.9% water, more preferably from about 50% to about 99.8%, most preferably from about 80% to about 99.7% water. As mentioned, it is alternatively envisaged that the cleaning composition may be non-aqueous. By “non-aqueous”, it is meant that the cleaning composition is substantially free from water. More precisely, it is meant that the cleaning composition does not contain any expressly added water and thus the only water that is present in the composition is present as water of crystallization for example in combination with a raw material. When the composition is in solid form, e.g. particulate or tablet, it is preferably dissolved in water prior to use.

### Textile Treating Composition

In another specific embodiment, the compositions are rinse added fabric conditioning compositions. Examples of typical rinse added conditioning composition can be found in WO 06/041954 and US 2006/0079438. The rinse added fabric conditioning compositions of the present invention comprise (a) fabric softening active and (b) a thiazolium dye.

In one embodiment of the invention, the fabric softening active (hereinafter “FSA”) is a quaternary ammonium compound suitable for softening fabric in a rinse step. In one embodiment, the FSA is formed from a reaction product of a fatty acid and an aminoalcohol obtaining mixtures of mono-, di-, and; in one embodiment, triester compounds. In another embodiment, the FSA comprises one or more softener quaternary ammonium compounds such, but not limited to, as a monoalkyquaternary ammonium compound, a diamido quaternary compound and a diester quaternary ammonium compound, or a combination thereof.

In one aspect of the invention, the FSA comprises a diester quaternary ammonium (hereinafter “DQA”) compound composition. In certain embodiments of the present invention, the DQA compounds compositions also encompasses a description of diamido FSAs and FSAs with mixed amido and ester linkages as well as the aforementioned diester linkages, all herein referred to as DQA.

A first type of DQA (“DQA (1)”) suitable as a FSA in the present CFSC includes a compound comprising the formula: {R₄₋ₘ—N⁺—[(CH₂)ₙ—Y—R¹]}X⁻

wherein each R substituent is either hydrogen, a short chain C₁-C₆, preferably C₁-C₃ alkyl or hydroxyalkyl group, e.g., methyl (most preferred), ethyl, propyl, hydroxyethyl, and the like, poly (C₂₋₃ alkoxy), preferably polyethoxy, group, benzyl, or mixtures thereof; each m is 2 or 3; each n is from 1 to about 4, preferably 2; each Y is —O—(O)C—, C(O)—O—, —NR—C(O)—, or —C(O)—NR— and it is acceptable for each Y to be the same or different; the sum of carbons in each R¹, plus one when Y is —O—(O)C— or —NR—C(O)—, is C₁₂-C₂₂, preferably C₁₄-C₂₀, with each R¹ being a hydrocarbyl, or substituted hydrocarbyl group; it is acceptable for R¹ to be unsaturated or saturated and branched or linear and preferably it is linear; it is acceptable for each R¹ to be the same or different and preferably these are the same; and X can be any softener-compatible anion, preferably, chloride, bromide, methylsulfate, ethylsulfate, sulfate, phosphate, and nitrate, more preferably chloride or methyl sulfate. Preferred DQA compounds are typically made by reacting alkanolamines such as MDEA (methyldiethanolamine) and TEA (triethanolamine) with fatty acids. Some materials that typically result from such reactions include N,N-di(acyl-oxyethyl)-N,N-dimethylammonium chloride or N,N-di(acyl-oxyethyl)-N,N-methylhydroxyethylammonium methylsulfate wherein the acyl group is derived from animal fats, unsaturated, and polyunsaturated, fatty acids, e.g., tallow, hardended tallow, oleic acid, and/or partially hydrogenated fatty acids, derived from vegetable oils and/or partially hydrogenated vegetable oils, such as, canola oil, safflower oil, peanut oil, sunflower oil, corn oil, soybean oil, tall oil, rice bran oil, palm oil, etc. Non-limiting examples of suitable fatty acids are listed in U.S. Pat. No. 5,759,990 at column 4, lines 45-66. In one embodiment the FSA comprises other actives in addition to DQA (1) or DQA. In yet another embodiment, the FSA comprises only DQA (1) or DQA and is free or essentially free of any other quaternary ammonium compounds or other actives. In yet another embodiment, the FSA comprises the precursor amine that is used to produce the DQA.

In another aspect of the invention, the FSA comprises a compound, identified as DTTMAC comprising the formula: [R₄₋ₘ—N^{(+)—R}¹ₘ]A⁻

wherein each m is 2 or 3, each R¹ is a C₆-C₂₂, preferably C₁₄-C₂₀, but no more than one being less than about C₁₂ and then the other is at least about 16, hydrocarbyl, or substituted hydrocarbyl substituent, preferably C₁₀-C₂₀ alkyl or alkenyl (unsaturated alkyl, including polyunsaturated alkyl, also referred to sometimes as “alkylene”), most preferably C₁₂-C₁₈ alkyl or alkenyl, and branch or unbranched. In one embodiment, the Iodine Value (IV) of the FSA is from about 1 to 70; each R is H or a short chain C₁-C₆, preferably C₁-C₃ alkyl or hydroxyalkyl group, e.g, methyl (most preferred), ethyl, propyl, hydroxyethyl, and the like, benzyl, or (R²O)₂₋₄H where each R² is a C₁₋₆ alkylene group; and A⁻ is a softener compatible anion, preferably, chloride, bromide, methylsulfate, ethylsulfate, sulfate, phosphate, or nitrate; more preferably chloride or methyl sulfate. Examples of these FSAs include dialkydimethylammonium salts and dialkylenedimethylammonium salts such as ditallowedimethylammonium and ditallowedimethylammonium methylsulfate. Examples of commercially available dialkylenedimethylammonium salts usable in the present invention are di-hydrogenated tallow dimethyl ammonium chloride and ditallowedimethyl ammonium chloride available from Degussa under the trade names Adogen® 442 and Adogen® 470 respectively. In one embodiment the FSA comprises other actives in addition to DTTMAC. In yet another embodiment, the FSA comprises only compounds of the DTTMAC and is free or essentially free of any other quaternary ammonium compounds or other actives.

In one embodiment, the FSA comprises an FSA described in U.S. Pat. Pub. No. 2004/0204337 A 1, from paragraphs 30-79.

In another embodiment, the FSA is one described in U.S. Pat. Pub. No. 2004/0229769 A1, on paragraphs 26-31; or U.S. Pat. No. 6,494,920, at column. 1, line 51 et seq. detailing an “esterquat” or a quaternized fatty acid triethanolamine ester salt.

In one embodiment, the FSA is chosen from at least one of the following: ditallowoyloxyethyl dimethyl ammonium chloride, dihydrogenated-tallowoyloxyethyl dimethyl ammonium chloride, ditallow dimethyl ammonium chloride, ditallowoyloxyethyl dimethyl ammonium methyl sulfate, dehydrogenated-tallowoyloxyethyl dimethyl ammonium chloride, dihydrogenated-tallowoyloxyethyl dimethyl ammonium chloride, or combinations thereof.

In one embodiment, the FSA may also include amide containing compound compositions. Examples of diamide comprising compounds may include but not limited to methyl-bis(tallowamidoethyl)-2-hydroxyethylammonium methyl sulfate (available from Degussa under the trade names Varisoft 110 and Varisoft 222). An example of an amide-ester containing compound is N-[3-(stearoylamino)propyl]-N-[2-(stearoyloxy)ethoxy)ethyl)]-N-methylamine.

Another specific embodiment of the invention provides for a rinse added fabric care composition further comprising a cationic starch. Cationic starches are disclosed in US 2004/0204337 A1. In one embodiment, the fabric care composition comprises from about 0.1% to about 7% of cationic starch by weight of the fabric care composition. In one embodiment, the cationic starch is HCP401 from National Starch:

### Cleaning Mechanisms of Cleaning Solutions

A novel mechanism for enhancing spreading and wetting of nano-fluid films and cleaning of solid surfaces, based on the phenomenon of ordered nanoparticle structure formation in the confined three-phase contact region (i.e., the wedge film) has recently been reported (Wasan et al., Nature, 423:156-159 (2003)). The significance of this finding goes well beyond spreading and wetting, and the cleaning of solid surfaces using nanofluids. The self structuring of nano-fluids in wedge and other thin films (and the resulting forces stabilizing these films) has broader technological applications in producing a diverse range of novel materials, including inorganic/organic nanostructuring materials and coatings, films with the desired optical and electrical properties (e.g., photonic crystals), and stabilizing of foams, emulsions and particle dispersions.

The cleaning performance, as defined by the time it takes for the soil to separate from a solid substrate using several commercially available nano-fluids, is presented in the following specific examples in detail to afford a better understanding of the invention, but should not be considered as limiting the invention. As shown in these examples, the positive contribution of nanoparticles (other than surfactant micelles) on cleaning performance was established. Two types of oily soils, including canola oil and hexadecane were used in the experimental tests. The substrates included glass, a sheet of cotton cloth and single cotton fibers.

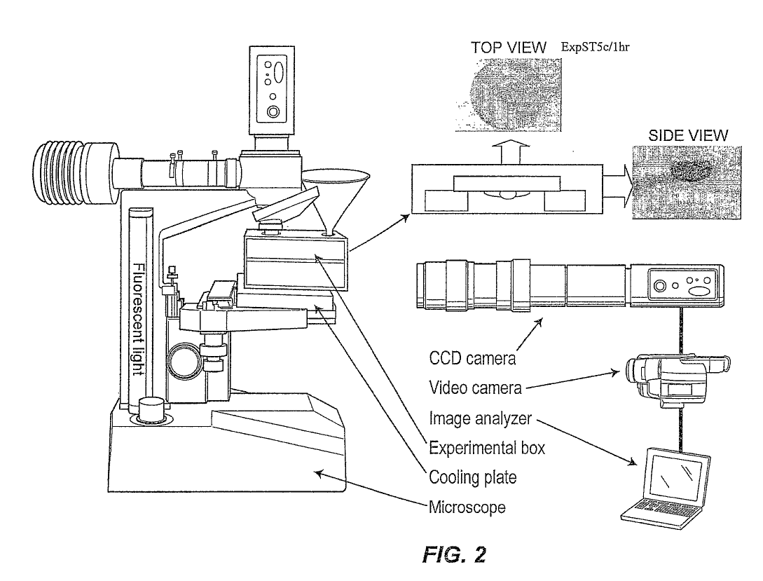

In order to monitor the interaction between the soil and substrate in the presence of nano-fluids, the reflected light microscopic method was used. The cleaning dynamics were monitored using the digital optical technique shown in FIG. 2.

The soil drop was placed on the lower part of the glass slide and monitored from the top as well as from the side simultaneously. A sessile drop forms when the buoyancy force presses the drop towards the supporting surface. Two square glass borders were used to lift the glass slides. The cleaning dynamics of the soil drop in different nano-fluids was monitored and recorded at 30 frames per second by a CCD camera and a video camera. The rate at which the wedge film (i.e., the three phase contact region) recedes (i.e., the rate of soil removal) due to the structural force was monitored. A small amount of red dye was added to the soil to better view the interaction between the soil and solid substrate. The soil was deposited on the substrate using a syringe.

The nano-fluids used in the cleaning experiments are silica suspensions of: Nalco 1130 produced by Nalco Co.; ‘SNOWTEX-C’ (ST-C), ‘SNOWTEX-40’ (ST-40), and ‘SNOWTEX-N’ (ST-N) produced by Nissan Chemical Industries; and a solution of metallic salt of ethylene-methacrylic acid copolymer (EMNAA) ‘CHEMIPEARL’ 5100 produced by Mitsui Chemical. The physical properties of nanofluids together with their soil cleaning performance are listed in Table 3. The data for nano-fluids concentration, nano-particle diameter, and suspension density are provided by the manufacturers. The particle effective diameter and polydispersity for all the nano-fluids except Nalco 1130 are obtained from the light scattering analysis performed by Procter and Gamble Co. The polydispersity is defined as the number average molecular weight divided by weight average molecular weight. The effective diameter of the Nalco 1130 nano-fluid was obtained by using our capillary force balance.

TABLE 3
Physical Properties of Nanofluids and Their Soil Cleaning Performance

| | Nanofluid | | | | | |
|---|---|---|---|---|---|---|
| | 1130 | ST-C | ST-40 | ST-N | S100 | Tide |
| Manufacturer | Nalco | Nissan | Nissan | Nissan | Mitsui | P&G |
| Nanoparticle | SiO₂ | SiO₂ | SiO₂ | SiO₂ | EMMA | N/A |
| Type | | | | | | |
| Orig. Conc. | 30 | 20 | 41 | 20 | 27 | 0.15 |
| (wt %) | | | | | | |
| Geo. Dia. (nm) | 9 | 10-20 | 10-20 | 10-20 | <100 | N/A |
| Eff. Dia. (nm) | 25 | 39 | 60 | 33 | 22 | N/A |
| Polydispersity | 0.15 | 0.27 | 0.24 | 0.22 | 0.16 | N/A |
| pH | 9.9 | 9.3 | 9.8 | 9.4 | 9.7 | 7.9 |
| Viscosity | 5.0 | 7.1 | 11.1 | 4.4 | 400 | N/A |
| (mPa * s) | | | | | | |
| Time to | 2.4 | 13 | 4.7 | 26 | 5.4 | 107 |
| separate | (30 wt %) | (20 wt %) | (10 wt %) | (20 wt %) | (14 wt %) | |
| Canola oil | | | | | | |
| (min.) | | | | | | |
| Time to | 0.13 | N/A | 0.7 | No sep. | 1.0 | N/A |
| separate | (15 wt % + | | (10 wt %) | | (14 wt %) | |
| hexadecane | 3E-3M | | | | | |
| (min.) | SDS) | | | | | |
| 2^{nd} virial | 4.7E−6 | 4.1E−6 | 3.3E−6 | 3.0E−6 | 1.0E−5 | 1.2E−5 |
| coefficient | | | | | | |
| (mol · cm³/g²) | | | | | | |
| Osmotic | 1581 | 6727 | 1221 | 8720 | 659 | 4 |
| pressure | (10 wt %) | (20 wt %) | (10 wt %) | (27 wt %) | (5 wt %) | |
| (dyne/cm²) | 3577 | | 4735 | | 4532 | |
| | (15 wt %) | | (20 wt %) | | (14 wt %) | |
| | 16493 | | 23024 | | 17101 | |
| | (30 wt %) | | (41 wt %) | | (27 wt %) | |

The pH of the nano-fluids was measured using pH meter model pH Tester 30. Professional pH buffer solutions obtained from Fisher Scientific USA were used for calibration in the pH range of experimental tests (i.e., pH of 7 to 11).

The nano-fluid SNOWTEX-C originally supplied by the manufacturers at pH=8.4 did not perform well, and therefore its pH was adjusted to 9.3 in order to improve its cleaning performance. The pH value of the nanofluids was adjusted by adding a concentrated hydroxide solution obtained from Fisher Scientific Co.

Sodium dodecyl sulfate (SDS) produced by BDH Chemicals Ltd., was used as a wetting agent; 100 ppm of SDS was added to the Nalco 1130 nano-fluid. A wetting agent, as used here, refers to an interface active substance which reduces the interfacial energy between the substrate where the pollutant is adhered and the cleaning composition. The wetting agent selectively adsorbs on substrate and enhances the cleaning composition spreading over the substrate. This relationship is described by the following equation:

γ*_{substrate/pollutant}−γ_{pollutant/nano-fluid} cos Θ−γ*_{substrate/nano-fluid}≦0

wherein γ*_{substrate/pollutant} is the interfacial energy substrate/pollutant, γ*_{substrate/nano-fluid} interfacial energy substrate/nano-fluid, γ_{pollutant/nano-fluid} interfacial tension pollutant/nano-fluid and Θ is the three phase contact angle: substrate/nano-fluid/pollutant. the detergent and wetting agent are both surfactants (surface or interfacial active substances). The difference between a detergent and wetting agent is that the detergent molecule is design to adsorb on a pollutant/fluid interface (e.g., water/oil) and to reduce significantly the interfacial tension while the wetting agent is designed to adsorb on solid/liquid interface and to reduce the interfacial energy. Some detergent and wetting agent molecules may operate as both wetting agents and detergents. For example, SDS (sodium dodecyl sulfate) is both a good wetting agent (e.g., to enhance water-glass wetting) and is also very good detergent which significantly reduces the interfacial tension between the oil/water interface. Aerosol OT (Sodium dioctyl sulfosuccinate) is an excellent wetting agent and enhances water wetting on most solids and is also a good detergent. A wetting agent is typically any surfactant having a HLB of about 7 to about 9, while a detergent will typically have a HLB of about 13 to about 15. Specifically, wetting agents include sodium dioctyl sulfosuccinate and PLURONIC™ (L92 or P103) surfactant block copolymers.

Tide detergent solution obtained from Procter and Gamble Co. (P&G) was also used and the cleaning performance of all the nano-fluids used in these tests was compared with that of Tide solution. The surface tensions of the Tide solution as well as the nanofluids were measured using the Interfacial Tensiometer KRUSS KS (Wilhemy slide method). The interfacial tension was obtained from the experimentally measured drop shape using the Laplace equation.

The static light scattering technique was used to measure the turbidity and refractive index of the various nano-fluids and the Tide detergent solution. Turbidity measurements were made using the Hach 21 OOA Turbidimeter and the refractive index measurements were made using a Fisher refractometer. The average molecular weight and the second virial coefficient for the various nano-fluids and the Tide solution were calculated using the turbidity and refractive index data. The osmotic pressure was calculated from the second virial coefficient and the molecular weight.

Capillary force balance in conjunction with the reflected light microinterferometric method was used to calculate the effective volume (concentration) of the nanofluid composition comprising nanoparticles with hydration layers, electrical double layers or surface grafter polymer layers.

Several specific examples are given below to illustrate the cleaning dynamics using nano-fluids. The following examples illustrate the compositions of the present invention but are not necessarily meant to limit or otherwise define the scope of the invention herein.

### EXAMPLES

### Example I

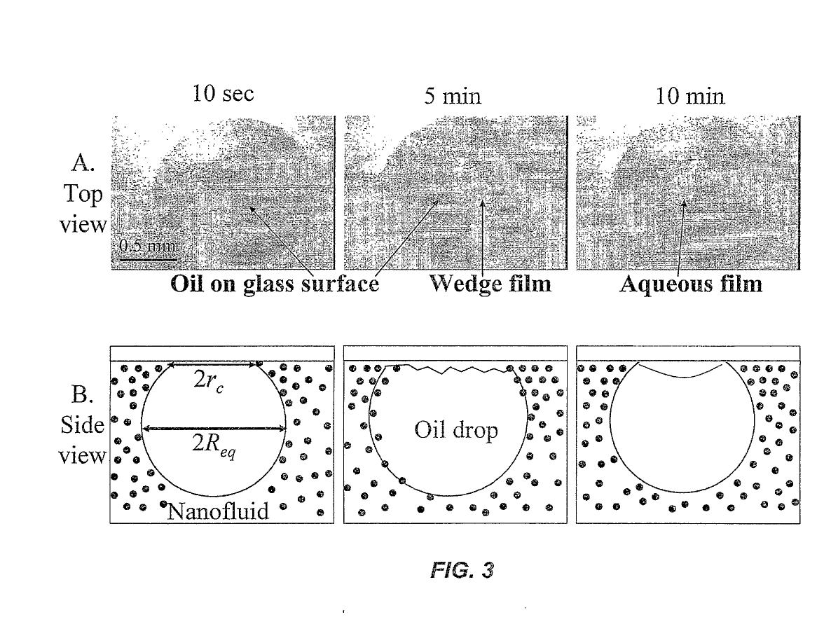

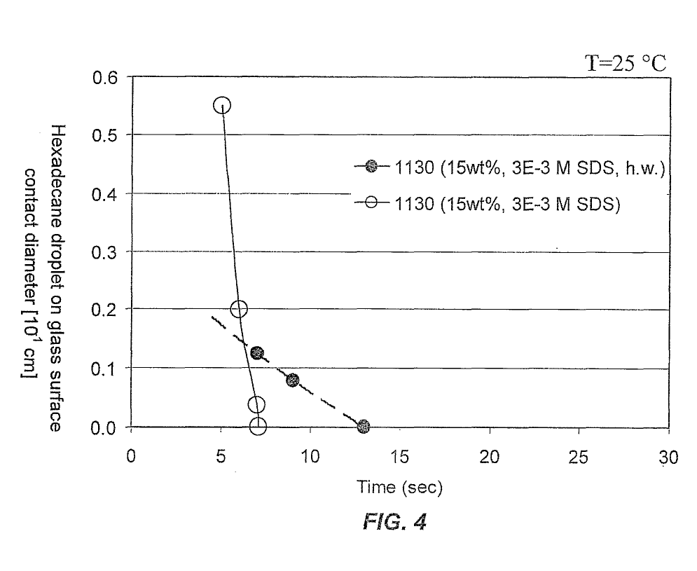

An aqueous suspension of 15 wt % hydrophilic silica particles having a diameter of 9 nm and a density of 1.2 15 g/cm was used as a nano-fluid together with sodium dodecyl sulfate (SDS, an anionic surfactant), as a solid surface modifier (a wetting agent that lowers the contact angle) at a concentration of 100 ppm. The pH of the nano-fluid was 9.8. The dynamics of the wedge film formation between the sessile drop of hexadecane as an oily soil and the glass as a substrate was monitored by reflected light microscopy (FIG. 2). Photomicrographs of the three-phase contact region (oiL'glass/nano-fluid) taken at increasing times after the addition of nano-fluid at 25° C. are shown in FIG. 3. The dynamics of the three-phase contact region (i.e., decrease in the three-phase contact diameter with time) is shown in FIG. 4. The sessile drop equator diameter (2 Req) and the threephase contact region diameter (2r are marked on FIG. 3b. Within a few seconds of adding the nano-fluid, the wedge film (i.e., the film of nano-fluid between the soil and substrate) grows, and separates the soil from the substrate. The total time for the soil to be fully removed from the glass surface was about 13 seconds for the nano-fluid Nalco 1130 with 3×10 M SDS (100 ppm) in hard water containing 6 grains per gallon of calcium and magnesium ions and 8 seconds in deionized water, respectively.

Soil cleaning-tests were also conducted using the same oily soil and the same nano fluid comprising hydrophilic silica nanoparticles, but without the addition of the wetting agent (SDS). Results showed that the nano-fluid (without SDS) did not remove any soil from the solid substrate. The cleaning performance of the nano fluid was reduced because there was no wetting agent (SDS) to lower the contact angle and promote the nano-fluid structure formation inside the wedge film.

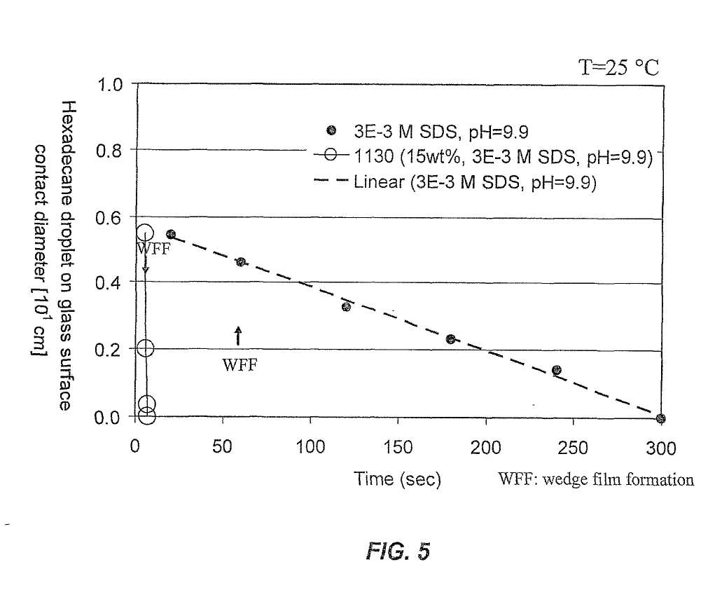

Cleaning tests were also performed with 3×10 M SDS solution along and these results are shown in FIG. 5. The results clearly show that the nano-fluid composed of nanoparticles with SDS added performed much better than the SDS alone. The wedge film formation (WFF) took longer in the case of SDS alone.

The second virial coefficient for the nano-fluid comprising 15 wt % silica nanoparticles and 100 ppm of SDS was determined using the light scattering method. Both the turbidity and the refractive index of the nano-fluid formulation were measured and the second virial coefficient was determined. Table 3 tabulates the value of the second virial coefficient. The value of the osmotic pressure for the nano-fluid formulation is determined using the virial coefficient is also given in Table 3. It is noted that the nano-fluid formulation of this example has both a positive second virial coefficient and high osmotic pressure.

The effective volume of the nano-fluid formulation inside the wedge film was determined by using our capillary force balance method. The effective volume of 15 wt % of nano-fluid formulation having 9 nm diameter silica particles was determined to be about 30 vol %.

### Example II

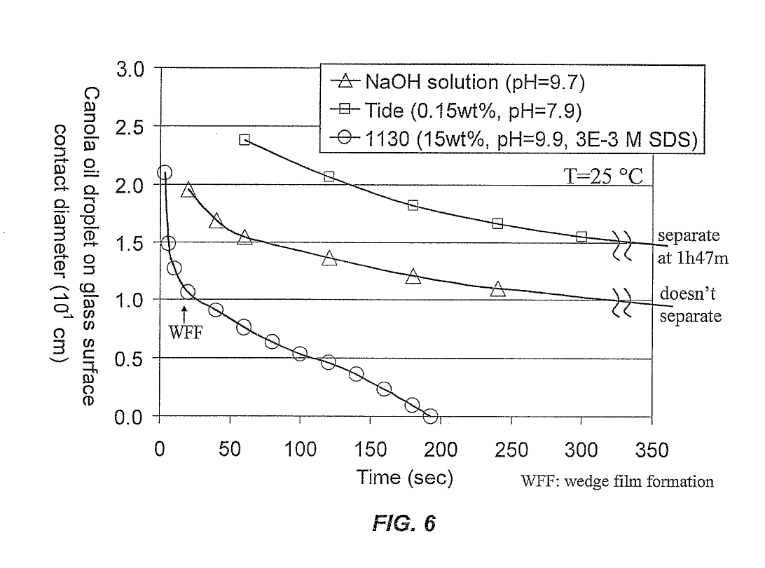

Another soil, besides hexadecane of Example I, canola oil (a greasy soil) with a density of 0.905 glcm at 25° C. was used. The cleaning performance of the nanofluid Nalco 1130 comprising 30 wt % hydrophilic silica nanoparticles of 9 nm diameter was also determined. The time to separate the oily soil (canola oil) from the glass surface at pH=9.9 was around 2 minutes. The dynamics of the three-phase contact region and the wedge film formation (WFF) with increasing time are shown in FIG. 6.

The soil cleaning performance of the nano-fluid formulation of Example II against canola oil at pH=9.9 was also compared with that of a common laundry detergent, Tide (a product of P&G). The time to separate the oily soil from the glass surface was nearly two hours for a 0.15 wt % Tide solution as compared to about 2 minutes for the nano-fluid of Example II. FIG. 6 compares the dynamics of the three-phase contact region with increasing times. The better performance of the Nalco 1130 can be attributed to having a much higher osmotic pressure compared that of the Tide solution.

Canola oil contains triglycerides. The triglycerides constitute 94.4 to 99% of the total lipid. Triglycerides can react with an alkaline solution at a pH of 9.7 and produce glycerol and a fatty acid salt, a soapy product. The soapy product can enhance the detergency action. Therefore, in order to reveal the interaction between canola oil as a soil with the glass substrate in the presence of an aqueous alkaline solution alone was investigated. The dynamics of the three-phase contact region is shown in FIG. 6. The soil separates from the substrate after a very long time (more than two hours) in the presence of aqueous alkaline solution alone at pH=9.7.

### Example III

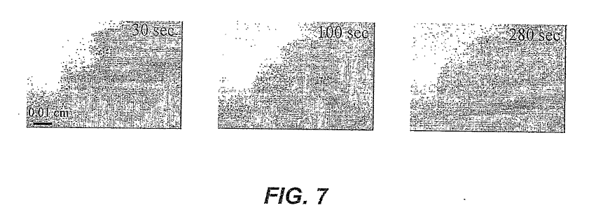

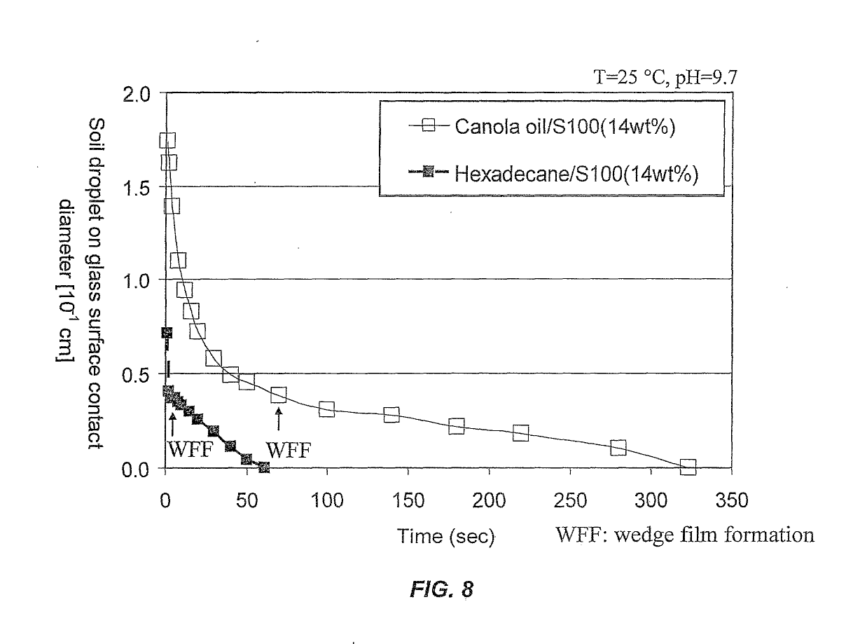

The cleaning performance of other commercially available nano-fluids was also tested to further illustrate the claims made by this invention. The nano-fluid comprising a metallic salt of ethylene-methacrylic acid copolymer (EMAA) “CHEMPEARL” S-100 (produced by MitsuiChemical) at a pH of 9.7 was tested against two soils, hexadecane and canola oil. FIG. 7 shows the photomicrographs depicting the dynamics of the wedge film formation between the soil (canola oil) and the glass substrate at 25° C. FIG. 8 shows the dynamics of the three-phase contact region and the time for the wedge film formation. The wedge film (marked by an arrow) is formed in less than 20 seconds for hexadecane and at about 75 seconds for canola oil. The total time for oily soil separation using 14 wt % of S-100 was about 5 minutes for canola oil and about 1 minute for hexadecane.

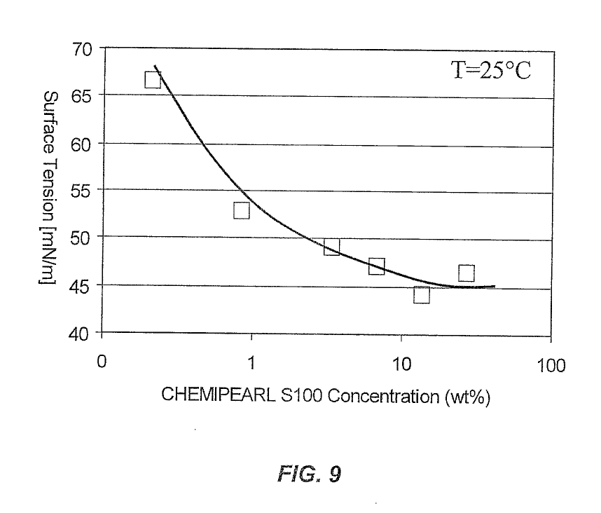

It should be noted that S-100 also contains surface active material and this is the main reason for the initial rapid shrinking of the oil drop (i.e., decrease of the three-phase contact region) as seen in FIG. 8. FIG. 9 shows the surface tension isotherm of S-100 at 25° C. The surface tension of S-100 decreases gradually when the concentration is increased. The surface tension of S-100 at 1 wt % is lower than for pure water (i.e., 72 mN/m). The surface tension data indicate that S-100 is surface active, adsorbs at an oiL'aqueous solution interface, and lowers the interfacial tension, which leads to a decrease in contact angle, thereby enhancing the wedge film formation The formulation of this example comprising nanoparticles of polymer (5-100) has both high osmotic pressure and a positive second virial coefficient and therefore has a good soil cleaning performance.

### Example IV

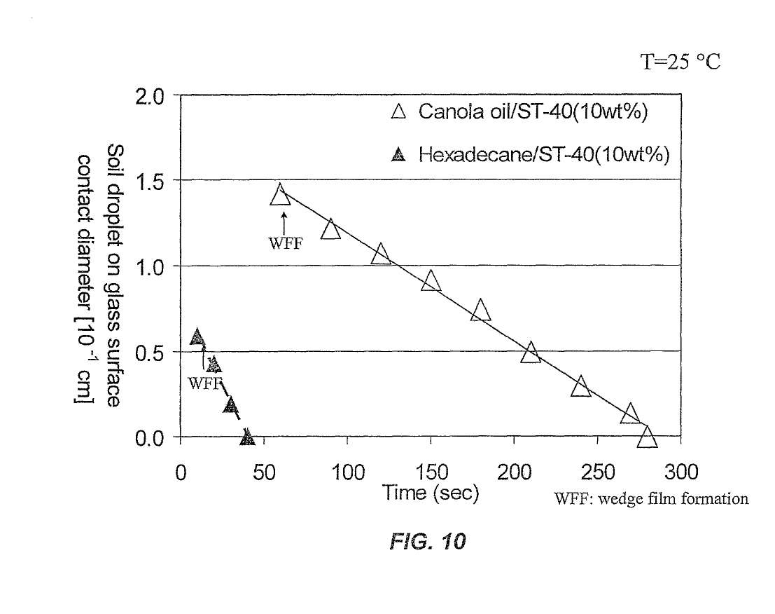

Another nano-fluid, SNOTEX-40 (ST-40) (produced by Nissan Chemical Industries) at a pH of 9.8 was tested for cleaning of both canola oil and hexadecane against a glass substrate. FIG. 10 shows the dynamics of the three-phase contact region with increasing time. The complete soil cleaning time was about 5 minutes using 10 wt % of ST-40 for canola oil, and was 40 seconds against hexadecane.

### Example V

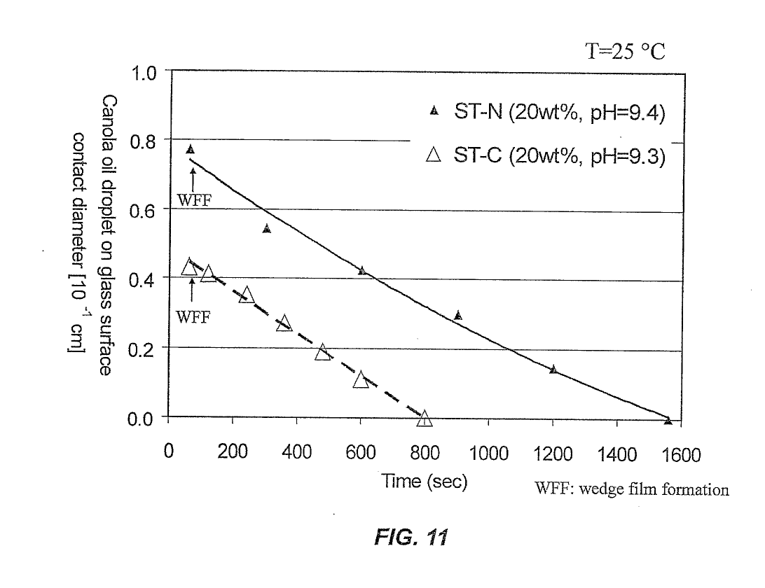

Two other commercially available nano-fluids, SNOWTEX-C (ST-C) and SNOWTEX-N (ST-N) (both produced by Nissan Chemical Industries) were tested for their cleaning performance against canola oil as a soil on the glass substrate. The time for soil removal for ST-C at 20 wt % was about 13 minutes and 26 minutes for ST-N at 20 wt % (FIG. 11). Both of these tests were conducted at a pH of about 9.3. Both of these nano-fluid formulations performed much better than the alkali solution alone (FIG. 6).

### Example VI

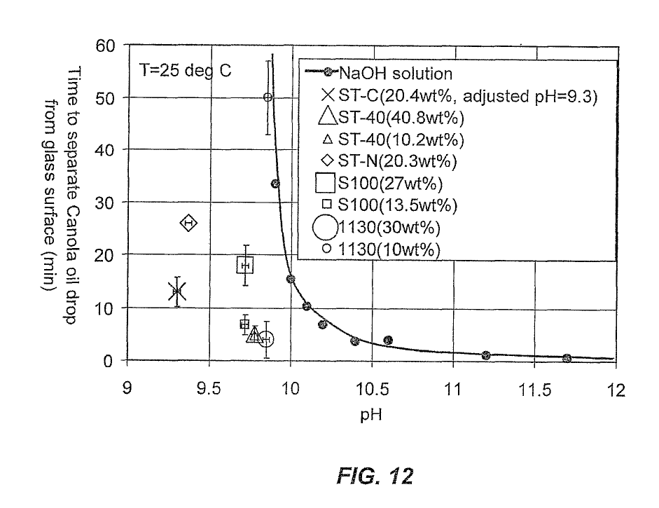

Soil cleaning tests were carried out using different concentrations of nano-fluid formulations of Examples I through V against canola oil as a soil on a glass surface. FIG. 12 shows the results for the time of separation of soil. This figure also compares these test results for the soil to separate from the glass in the absence of any nanoparticles (i.e., alkali solution alone). It is clearly evident that all the nano fluids comprising nanoparticles performed better than the alkali solution alone at a pH value below 10.

### Example VII

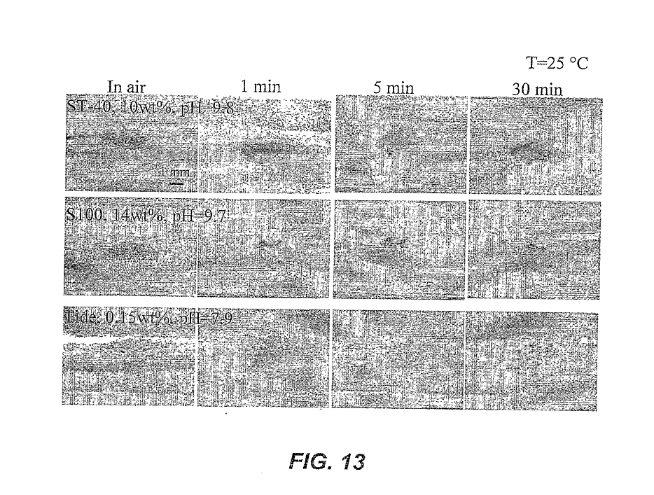

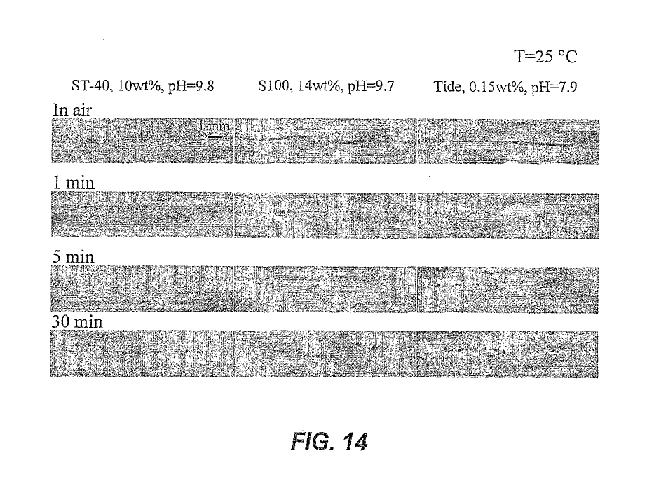

The cleaning action of nano-fluid formulations of S-100 and ST-40 was tested against canola oil on both a textile cotton sheet and a single cotton fiber. FIGS. 13 and 14 show the photomicrographs of the cleaning action with increasing times. The cleaning dynamics of the ST-40 and S-100 are also compared with those of the Tide solution. When the soiled cotton sheet is immersed in these formulations, tiny soil droplets appear on the fiber of the cotton sheet. With time, the soil droplets begin to separate from the fiber surface. The cleaning mechanism of soil on the textile sheet was monitored using a single cotton fiber which was separated from the textile cotton and soiled with canola oil, and immersed into the nano-fluid formulation. The soil on the fiber surface breaks into tiny droplets over time, and the three-phase contact region shrinks (this phenomenon is just like the one on the glass surface) and after some time the droplets separate from the fiber and move upwards by the buoyancy force. The three-phase contact region initially shrinks because of the lowering of the interfacial tension. The size of the droplet formed on the cotton surface was the largest for S-100 indicating that it has the best cleaning performance. These tests were conducted using the same (as in Examples III and IV) nano-fluid formulations of ST-40 at 10 wt %, S-100 at 14 wt % and Tide solution at 0.15 wt %.

### Example VIII

The effect of shear flow on the separation of an oily soil from the glass surface as well as the cotton sheet was investigated. The soiled surface was immersed into the cleaning nano-fluid formulation and a moderate shear flow was created over the surface of the soiled surface (glass or cotton sheet). The cleaning action was monitored and recorded. It was observed that the flow enhances the separation of tiny droplets from the soiled surface. These test results showed that the oily soil drop could be removed from the solid substrate in an even shorter time. Hence, it was demonstrated that the nano-fluid can be used in conjunction with flow to improve cleaning performance.

### Test Methods

### Grass and Grease Stain Removal Index

The nanoparticles are tested for their ability to remove stains, grass stains and grease stains in particular, according to the stain removal process described in U.S. patent application 2003/0035757 A1 filed by Novozymes North America, Inc. on Nov. 27, 2001. Particularly, the nanoparticles are tested by a process similar to Example 15 of U.S. 2003/0035757 A1.

The different nanoparticle fluids were tested for their ability to remove grass or grease stains from fabric using a test devise which was a carousel construction comprising a horizontal rotatable support disc comprising means for fastening, in a position different from the rotational centre, of 4, 96-well microplates sealed with stained fabric. The stained fabric are purchase from Equest and EMC. Each well contained in addition to liquid sample 5 solid magnetic implements for providing mechanical stress. The carousel construction also comprises a fixed permanent magnet which was positioned to enable passing the microplates under the magnet by rotating the support disc in sufficient proximity to cause the magnetic implements in the wells to be attracted by the magnet and to-collide with the stained fabric. The carousel further comprised an electric engine for rotating the support disk at a constant rate.

Samples of nanoparticle fluids (8 replicas) at the desired concentrations were mixed, in each well, with water having a hardness of 0 grains per gallon. The stained fabrics impregnated with a either a grass or a hamberger stain was positioned over the microplates covering all the wells and the fabric was fixed using a lid. A washing process was now simulated by rotating the support disk at a constant speed so that the microplates continuously passed closely under the magnet, whereby the magnetic implements were lifted towards the magnet thereby colliding with the fabric sealing the wells. This process was continued for 12 minutes at 25° C. Simultaneously, 8 replicas of a control solution of water only, again having a hardness of 0 grains per gallon, were run against the respective stained fabrics.

After completing the simulated washing process the light reflectance of previously stained fabrics were measured as an indication of how much of the stain which had been cleaned off by each nanoparticle fluid. The light reflectance results of the respective nanoparticle fluid were divided by the light reflectance results of the water samples to obtain a ratio index. These indices are called the Stain Removal Index as related to either grass or grease.

### Examples VIII-XII

### Example VIII(a)-(f)

### Liquid Laundry Detergent Formulas

| | VIIIa | VIIIb | VIIIc | VIIId | VIIIe | VIIIf⁵ |
|---|---|---|---|---|---|---|
| Ingredient | wt % | wt % | wt % | wt % | wt % | wt % |
| Sodium alkyl ether sulfate | 14.4% | 14.4% | | 9.2% | 5.4% | |
| Linear alkylbenzene sulfonic | 4.4% | 4.4% | 12.2% | 5.7% | 1.3% | |
| acid | | | | | | |
| Alkyl ethoxylate | 2.2% | 2.2% | 8.8% | 8.1% | 3.4% | |
| Amine oxide | 0.7% | 0.7% | 1.5% | | | |
| Citric acid | 2.0% | 2.0% | 3.4% | 1.9% | 1.0% | 1.6% |
| Fatty acid | 3.0% | 3.0% | 8.3% | | | 16.0% |
| Protease | 1.0% | 1.0% | 0.7% | 1.0% | | 2.5% |
| Amylase | 0.2% | 0.2% | 0.2% | | | 0.3% |
| Lipase | | | | 0.2% | | |
| Borax | 1.5% | 1.5% | 2.4% | 2.9% | | |
| Calcium and sodium formate | 0.2% | 0.2% | | | | |
| Formic acid | | | | | | 1.1% |
| Amine ethoxylate polymers | 1.8% | 1.8% | 2.1% | | | 3.2% |
| Sodium polyacrylate | | | | | 0.2% | |
| Sodium polyacrylate | | | | 0.6% | | |
| copolymer | | | | | | |
| DTPA¹ | 0.1% | 0.1% | | | | 0.9% |
| DTPMP² | | | 0.3% | | | |
| EDTA³ | | | | | 0.1% | |
| Fluorescent whitening agent | 0.15% | 0.15% | 0.2% | 0.12% | 0.12% | 0.2% |
| Ethanol | 2.5% | 2.5% | 1.4% | 1.5% | | |
| Propanediol | 6.6% | 6.6% | 4.9% | 4.0% | | 15.7% |
| Sorbitol | | | | 4.0% | | |
| Ethanolamine | 1.5% | 1.5% | 0.8% | 0.1% | | 11.0% |
| Sodium hydroxide | 3.0% | 3.0% | 4.9% | 1.9% | 1.0% | |
| Sodium cumene sulfonate | | | 2.0% | | | |
| Silicone suds suppressor | | | 0.01% | | | |
| Perfume | 0.3% | 0.3% | 0.7% | 0.3% | 0.4% | 0.6% |
| Opacifier⁶ | | | 0.30% | 0.20% | | 0.50% |
| Nanomer 4 ™ | 5% | | 10% | 2% | 1% | 5% |
| Snowtex N ™ | | 20% | | | | |
| Water | balance | balance | balance | balance | balance | balance |
| | 100.0% | 100.0% | 100.0% | 100.0% | 100.0% | 100.0% |

¹diethylenetriaminepentaacetic acid, sodium salt
²diethylenetriaminepentakismethylenephosphonic acid, sodium salt
³ethylenediaminetetraacetic acid, sodium salt
⁴a non-tinting dye used to adjust formula color
⁵compact formula, packaged as a unitized-dose in polyvinyl alcohol film
⁶Acusol OP 301

### Example IX(a)-(c)

### Granular Detergent Formulas

| | IX a | IX b | IX c |
|---|---|---|---|
| Ingredient | wt % | wt % | wt % |
| Na linear alkylbenzene sulfonate | 3.4% | 3.3% | 11.0% |
| Na alkylsulfate | 4.0% | 4.1% | |
| Na alkyl sulfate (branched) | 9.4% | 9.6% | |
| Alkyl ethoxylate | | | 3.5% |
| Type A zeolite | 37.4% | 35.4% | 26.8% |
| Sodium carbonate | 22.3% | 22.5% | 35.9% |
| Sodium sulfate | 1.0% | | 18.8% |
| Sodium silicate | | | 2.2% |
| Protease | 0.1% | 0.2% | |
| Sodium polyacrylate | 1.0% | 1.2% | 0.7% |
| Carboxymethylcellulose | | | 0.1% |
| PEG 600 | | 0.5% | |
| PEG 4000 | | 2.2% | |
| DTPA | 0.7% | 0.6% | |
| Fluorescent whitening agent | 0.1% | 0.1% | 0.1% |
| Sodium perborate monohydrate | | | |
| Sodium percarbonate | | 5.0% | |
| Sodium nonanoyloxybenzenesulfonate | | 5.3% | |
| Silicone suds suppressor | 0.02% | 0.02% | |
| Perfume | 0.3% | 0.3% | 0.2% |
| Nanomer 4 ™ | 5% | 2.5% | |
| Snowtex N ™ | | | 10% |
| Water and miscellaneous | balance | balance | balance |

¹ formulated as a particle containing 1% dye, 34% tallow alcohol(EO)25, 65% sodium sulfate & moisture
² formulated as a particle containing 0.5% dye, 99.5% PEG 4000

### Example X(a)-(d)

### Rinse Added Fabric Conditioning Formulas

| Ingredient | Xa | Xb | Xc | Xd |
|---|---|---|---|---|
| Fabric Softening | 13.70% | 13.70% | 13.70% | 13.70% |
| Active^{a} | | | | |
| Ethanol | 2.14% | 2.14% | 2.14% | 2.14% |
| Cationic Starch^{b} | 2.17% | 2.17% | 2.17% | 2.17% |
| Perfume | 1.45% | 1.45% | 1.45% | 1.45% |
| Phase Stabilizing | 0.21% | 0.21% | 0.21% | 0.21% |
| Polymer^{c} | | | | |
| Calcium Chloride | 0.147% | 0.147% | 0.147% | 0.147% |
| DTPA^{d} | 0.007% | 0.007% | 0.007% | 0.007% |
| Preservative^{e} | 5 ppm | 5 ppm | 5 ppm | 5 ppm |
| Atifoam^{f} | 0.015% | 0.015% | 0.015% | 0.015% |
| Tinopal CBS-X^{g} | 0.2 | 0.2 | 0.2 | 0.2 |
| Ethoquad C/25^{h} | 0.26 | 0.26 | 0.26 | 0.26 |
| Ammonium | 0.1% | 0.1% | 0.1% | 0.1% |
| Chloride | | | | |
| Nanomer 4 ™ | 5% | 10% | 1% | |
| Snowtex N ™ | | | | 5% |
| Hydrochloric Acid | 0.012% | 0.012% | 0.012% | 0.012% |
| Deionized Water | Balance | Balance | Balance | Balance |

^{a}N,N-di(tallowoyloxyethyl)-N,N-dimethylammonium chloride.
^{b}Cationic starch based on common maize starch or potato starch, containing 25% to 95% amylose and a degree of substitution of from 0.02 to 0.09, and having a viscosity measured as Water Fluidity having a value from 50 to 84.
^{c}Copolymer of ethylene oxide and tercphthalate having the formula described in U.S. Pat. No. 5,574,179 at col. 15, lines 1-5, wherein each X is methyl, each n is 40, u is 4, each R¹ is essentially 1,4-phenylene moieties, each R² is essentially ethylene, 1,2-propylene moieties, or mixtures thereof.
^{d}Diethylenetriaminepentaacetic acid.
^{e}KATHON ® CG available from Rohm and Haas Co.
^{f}Silicone antifoam agent available from Dow Corning Corp. under the trade name DC2310.
^{g}Disodium 4,4′-bis-(2-sulfostyryl) biphenyl, available from Ciba Specialty Chemicals.
^{h}Cocomethyl ethoxylated [15] ammonium chloride, available from Akzo Nobel.

### Example XI(a)-(b)

### Liquid Dish Handwashing Formulas

| Composition | XIa | XIb |
|---|---|---|
| C₁₂₋₁₃ Natural AE0.6S | 29.0 | 29.0 |
| C₁₀₋₁₄ mid-branched Amine | — | 6.0 |
| Oxide | | |
| C₁₂₋₁₄ Linear Amine Oxide | 6.0 | — |
| SAFOL ® 23 Amine Oxide | 1.0 | 1.0 |
| C₁₁E₉ Nonionic² | 2.0 | 2.0 |
| Ethanol | 4.5 | 4.5 |
| Sodium cumene sulfonate | 1.6 | 1.6 |
| Polypropylene glycol 2000 | 0.8 | 0.8 |
| NaCl | 0.8 | 0.8 |
| 1,3 BAC Diamine³ | 0.5 | 0.5 |
| Suds boosting polymer⁴ | 0.2 | 0.2 |
| Nanomer 4 ™ | 5% | |
| Snowtex N ™ | | 5% |
| Water | Balance | Balance |

*Composition A is representative of an undesired viscosity.
¹C₁₂₋₁₃ alkyl ethoxy sulfonate containing an average of 0.6 ethoxy groups.
²Nonionic may be either C₁₁ Alkyl ethoxylated surfactant containing 9 ethoxy groups.
³1,3, BAC is 1,3 bis(methylamine)-cyclohexane.
⁴(N,N-dimethylamino)ethyl methacrylate homopolymer.

### Example XII(a)-(e)

### Automatic Dishwasher Detergent Formulas

| | XIIa | XIIb | XIIc | XIId | XIIe |
|---|---|---|---|---|---|
| Polymer dispersant¹ | 0.5 | 5 | 6 | 5 | 5 |
| Carbonate | 35 | 40 | 40 | 35-40 | 35-40 |
| Sodium tripolyphosphate | 0 | 6 | 10 | 0-10 | 0-10 |
| Silicate solids | 6 | 6 | 6 | 6 | 6 |
| Bleach and bleach activators | 4 | 4 | 4 | 4 | 4 |
| Enzymes | 0.3-0.6 | 0.3-0.6 | 0.3-0.6 | 0.3-0.6 | 0.3-0.6 |
| Disodium citrate dihydrate | 0 | 0 | 0 | 2-20 | 0 |
| Nonionic surfactant² | 0 | 0 | 0 | 0 | 0.8-5 |
| Nanomer 4 ™ | 2% | | 5% | 1% | 0.5% |
| Snowtex N ™ | | 10% | | | |
| Water, sulfate, perfume, | Balance | Balance | Balance | Balance | Balance |
| dyes and other adjuncts | To 100% | To 100% | To 100% | To 100% | To 100% |

¹Such as ACUSOL ® 445N available from Rohm & Haas or ALCOSPERSE ® from Alco.
²such as SLF-18 POLY TERGENT from the Olin Corporation

The test methods disclosed in the Test Methods Section of the present application must be used to determine the respective values of the parameters of Applicants' inventions.

Unless otherwise noted, all component or composition levels are in reference to the active level of that component or composition, and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited in the Detailed Description are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed:

1. A cleaning composition comprising a plurality of water insoluble nanoparticles in a suspension medium, each of the nanoparticles having an effective diameter of about 65 nanometers or less and including a metal compound, a semimetal compound, or a hydrophilic globular-sized polymer.

2. The cleaning composition of claim 1, wherein the nanoparticles are spherical.

3. The cleaning composition of claim 1, wherein the nanoparticles are in an amount that is from about 0.001% to about 25% of effective volume of the total cleaning composition.

4. The cleaning composition of claim 1, wherein the nanoparticles are in an amount that is from about 5% to about 25% of effective volume of the total cleaning composition.

5. The cleaning composition of claim 1, wherein the nanoparticles have an effective diameter of about 40 nanometers or less.

6. The cleaning composition of claim 1, wherein the nanoparticles have an effective diameter of about 5 to about 25 nanometers.

7. The cleaning composition of claim 1, wherein the nanoparticles have an effective diameter of about 10 to about 65 nanometers.

8. The cleaning composition of claim 1 comprising a grass stain removal index greater than 0 and a grease stain removal index greater than 0.

9. The cleaning composition of claim 1, wherein the cleaning composition is a laundry detergent, a liquid dishwashing detergent, a car cleaning composition, a textile treating composition, or an industrial degreasing composition.

10. The cleaning composition of claim 1 wherein the nanoparticles comprise silicon dioxide, titanium dioxide, zinc oxide, aluminum oxide, ethylene-methacrylic acid copolymer, particles derived from natural minerals, synthetic particles, or combinations thereof.

11. A cleaning composition comprising a plurality of water insoluble nanoparticles in a suspension medium in an amount that is from about 0.001% to about 25% of effective volume of the total cleaning composition, each of the nanoparticles having an effective diameter of about 65 nanometers or less and including a metal or semimetal compound, wherein the cleaning composition includes adjunct materials and is a laundry detergent, a liquid dishwashing detergent, a car cleaning composition, a textile treating composition, or an industrial degreasing composition having a grass stain removal index of greater than 0 and a grease stain removal index of greater than 0.

12. The cleaning composition of claim 11, wherein the nanoparticles comprise silicon dioxide, titanium dioxide, zinc oxide, aluminum oxide, ethylene-methacrylic acid copolymer, particles derived from natural minerals, synthetic particles, or combinations thereof.

13. The cleaning composition of claim 11, wherein the nanoparticles have an effective diameter of about 40 nanometers or less.

14. The cleaning composition of claim 11, wherein a surface of the nanoparticle comprises a hydration layer, an electrical double layer, one or more grafted polymers, or a combination thereof.

15. The cleaning composition of claim 11, further comprising a wetting agent.

16. The cleaning composition of claim 15, wherein the wetting agent comprises sodium dodecyl sulfate.

17. The cleaning composition of claim 11, having an osmotic pressure of at least 650 Pa at ambient temperature.

18. The cleaning composition of claim 11, wherein the nanoparticles have a standard deviation of less than 10% of their mean diameter.

19. The cleaning composition of claim 18, wherein the nanoparticles are monodisperse.

20. The cleaning composition of claim 11, wherein the nanoparticles comprise about 5% to about 25% of the effective volume of the total cleaning composition.
